(19) United States
(12) Patent Application Publication
(10) Pub. No.: US 2006/0079612 A1
(43) Pub. Date: Apr. 13, 2006

(54) Flame retardant coatings

(76) Inventors: Malisa Troutman, New York, NY (US); Ramanathan Ravichandran, Suffern, NY (US); Juerg Zingg, Reinach (CH); Roswell E. King, Pleasantville, NY (US)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/266,851

(22) Filed: Nov. 3, 2005

Related U.S. Application Data
(63) Continuation of application No. 10/406,484, filed on Apr. 3, 2003.
(60) Provisional application No. 60/371,355, filed on Apr. 10, 2002.
(60) Provisional application No. 60/416,933, filed on Oct. 8, 2002.

(51) Int. Cl. C08K 5/34

(52) U.S. Cl. 524/99

(57) ABSTRACT

Provided are flame retardant coating compositions and articles coated therewith, which compositions comprise (A) a coating and (B) an effective flame retarding amount of a mixture of (i) at least one compound selected from the group consisting of the (a) sterically hindered nitroxyl stabilizers, (b) sterically hindered hydroxylamine stabilizers and (c) sterically hindered alkoxyamine stabilizers and (ii) at least one conventional flame retardant selected from the group consisting of (d) organohalogen flame retardants, (e) organophosphorus flame retardants, (f) isocyanurate flame retardants and (g) melamine based flame retardants. The coated articles are for example iron, steel, stainless steel, aluminum and other non-ferrous metals, wood, plywood, paper, cardboard, chip board, particle board, plastics, thermoplastics, epoxies, neoprene, rubber, composites, fiberglass reinforced composites, polyesters, polymeric foam, masonry, fabric or textiles, wire and cable constructions and circuit boards.

The instant invention pertains to flame retardant coatings that comprise at least one sterically hindered nitroxyl, hydroxylamine or alkoxyamine compound, and at least one conventional flame retardant.

### BACKGROUND OF THE INVENTION

U.S. Pat. No. 5,096,950 discloses the co-use of certain NOR (N-alkoxy) hindered amines with a brominated Sb₂O₃-containing flame retardant in polypropylene.

U.S. Pat. No. 5,393,812 discloses polyolefin compositions which are made flame retardant by a combination of a halogenated hydrocarbyl phosphate or phosphonate ester flame retardant in combination with a alkoxyamine functional hindered amine.

U.S. Pat. No. 5,844,026 discloses polyolefin compositions comprising certain NOR hindered amines and certain conventional flame retardants.

U.S. Pat. No. 6,117,995 discloses that certain N-alkoxy hindered amines may be used as flame retardants for organic polymers.

U.S. Pat. No. 6,271,377 discloses polyolefin compositions that comprise N-hydroxyalkoxy hindered amines and a halogenated flame retardant.

U.S. Pat. No. 6,309,987 and equivalent WO 99/54530 teach polyolefin non-woven flame retardant fabrics that comprise N-alkoxyamines.

A Revolutionary UV Stable Flame Retardant System for Polyolefins—R. Srinivasan, A. Gupta and D. Horsey, Int. Conf. Addit. Polyolefins 1998, 69-83, teaches polyolefins comprising certain NOR hindered amines with halogen and phosphorus containing conventional flame retardants.

Advances in a Revolutionary Flame Retardant System for Polyolefins—R. Srinivasan, B. Rotzinger, Polyolefins 2000, Int. Conf. Polyolefins 2000, 571-581, teaches polyolefins comprising certain NOR hindered amines with brominated and phosphorus containing flame retardants.

N. Kaprinidis and R. King, in an abstract posted on the Society of Plastics Engineers website, posted September 2001, discuss the use of NOR hindered amines as flame retardants in polyolefins. The abstract is for a paper submitted to the Polymer Modifiers and Additives Division subsection to be presented at the Polyolefins 2002 conference in Houston, Tex., Feb. 24, 2002. The website is www.PMAD.org.

EP 0792911 A2, discloses polyolefin compositions that comprise alkoxyamine functional hindered amines and tris(trihalogenopentyl) phosphate flame retardants.

WO 99/00450, copending U.S. application Ser. No. 09/502,239, filed Nov. 3, 1999, and Ser. No. 09/714,717, filed Nov. 16, 2000, disclose the use of certain N-alkoxy hindered amines as flame retardants.

EP 568354, U.S. Pat. No. 6,084,008 and U.S. Pat. No. 5,723,515 describe fire-resistant coatings.

The flame retardant (FR) market today is comprised of products which function to interfere with the combustion process by chemical and/or physical means. Mechanistically these FRs have been proposed to function during combustion of an article in either the gas phase, the condensed phase or both. The organohalogens are proposed to generate halogen species (e.g. HX) which interferes in the gas phase with free radical organic “fuel” from the polymer substrate. Synergists are proposed to react with HX to form additional chemical species which interfere with combustion in the gas phase, such as reaction of antimony oxide with HX to form antimony halide and water vapor. Antimony compounds such as antimony trioxide also act as a radical scavenger forming antimony halides. Thus, it can inhibit the propagation of the fire.

Although antimony compounds are efficient in terms of cost performance, it recently raised a lot of concern because of the toxicity of the byproducts which are formed during combustion in the presence of a halogenated flame retardant. Antimony oxides often contain trace amounts of arsenic compounds which are suspected carcinogens. Because of these ecological concerns, there is a motion to replace antimony trioxide in the present commercial flame retardant applications. However, it is very difficult to find an effective synergist which is both enviromentally friendly and efficient as far as the cost performance is concerned.

Another reason to add flame retardant additives is to prevent dripping during the application of the fire. Dripping during combustion is the process of the separation of parts of the polymer from the matrix in the shape of droplets. Most often, the droplets are flaming and are imposing tremendous danger for fire spread. It is a common measure to add fillers such talc in large amounts to the polymer, with some negative consequences on the mechanical properties. Other fillers sometimes used include calcium carbonate, magnesium carbonate, zinc borate, silicates, silicones, glass fibres, glass bulbs, asbestos, kaolin, mica, barium sulfate, calcium sulfate, metal oxides, hydrates and hydroxides such as zinc oxide, magnesium hydroxide, alumina trihydrate, silica, calcium silicate, magnesium silicate.

It has been found that coatings with good flame retardant properties are prepared when the coatings comprise at least one compound selected from the group consisting of the sterically hindered nitroxyl, hydroxylamine and alkoxyamine additives and at least one certain conventional flame retardant. With the use of these flame retardant additive combinations, antimony compounds and fillers may be largely reduced or replaced. As the instant sterically hindered additives are active as stabilizers, the coating compositions of the invention are efficiently protected from the deleterious effects of light, oxygen and/or heat.

### DETAILED DISCLOSURE

The instant invention pertains to flame retardant coating compositions which comprise

(A) a coating and

(B) an effective flame retarding amount of a mixture of
(i) at least one compound selected from the group consisting of the
   (a) sterically hindered nitroxyl stabilizers,
   (b) sterically hindered hydroxylamine stabilizers and
   (c) sterically hindered alkoxyamine stabilizers and
(ii) at least one conventional flame retardant selected from the group consisting of
   (d) organohalogen flame retardants,
   (e) organophosphorus flame retardants,
   (f) isocyanurate flame retardants and
   (g) melamine based flame retardants.

The additive combination of components (i) and (ii) is synergistic towards providing flame retardancy to coatings.

Coatings

The coating component (A) of the present invention is a coating layer. It is for example a cured paint, varnish, adhesive or sealant layer. Alternatively, it is a thin plastic layer, for example an extruded thermoplastic coating as further described herein.

A paint or varnish formulation comprises resin, solvent, pigments, fillers, surfactants, and other typical components.

The present fire retardant coatings are suitable for example in the fields of construction, transportation, telecommunications, utilities, marine, chemical, petroleum, manufacturing and military, the hygiene sector, the medical sector, the textile and clothing industry, automobile applications, packaging, pharmacy, electrical engineering, electronics and domestic appliances.

Suitable substrates for the present coatings are for example iron, steel, stainless steel, aluminum and other non-ferrous metals, wood, plywood, paper, cardboard, chip board, particle board, plastics, PVC (polyvinyl chloride), thermoplastics, thermoplastic polyolefin, epoxies, neoprene, rubber, composites and the like.

The present coating materials can be used on most substrates and in severe climatic and environmental conditions where heat, light, oxygen and humidity are potential degradants. The coatings are suitable for the interior and exterior of homes, roofs, factories, commerical buildings, airplanes, vehicles, ships, boats, sailboats and the like.

Plastics and composites are suitable substrates according to this invention, for example fiberglass reinforced composites, polyesters, polymeric foam and thermoplastic resins such as polyolefins and thermoplastic polyolefins (TPO).

The coatings of this invention are suitable for use in painted automotive thermoplastic olefin structures.

The present coatings are advantageously used in marine applications such as bulkheads, piers, docks, cabin penetration barriers, cables, conduits, cargo areas, cabins and floors and off-shore drilling applications.

The present coatings may be employed in transportation applications, for example in autos, buses, trucks, cargo ships and airplanes, for coating vehicular undercarriages, exhaust systems, gas tanks, fire walls, engine compartments, catalytic converters, hoods, cargo liner patches, airport loading bridges, etc.

The present coatings are advantageously employed in the telecommunications, computer, utilities, petroleum and chemical industries, for example in cable and conduit wraps, optical fiber coatings, grease filled wire and cable, communications towers, fire penetration barriers, seals, pipeline wraps, storage tanks, reactors, ovens, distillation columns, furnaces and the like.

The coatings of this invention are suitable as coatings for circuit boards, for example radiation-curable coatings for circuit boards.

The present coatings are suitable as a cable coating to serve as a fire-stop for electrical, control and communications cables, for example cables grouped together in cable trays and raceways, junction boxes, cable trenches and similar applications.

Suitable optical fiber coatings are disclosed for example in U.S. Pat. Nos. 6,187,835, 6,350,790, 6,197,422 and 6,362,249, the disclosures of which are hereby incorporated by reference.

The coatings of this invention are suitable for architectural paints, for example flat, low, semi or high gloss finishes, for example as the primer or final coat.

The present coatings may be advantageously applied to exterior siding, interior structures, roofing, garages, ceilings, penetration barriers, PVC wrappings and the like. They may be employed in private homes, hotels and offices, for example as applied to wallpaper, paneling, drywall, wallboard, wainscoting, trusses, flooring and subflooring, studs, architectural millwork and trim, tiles, exterior decks, ceiling tiles, kitchen cabinets, kitchen hoods, carpet backing, interior walls, doors, file cabinets, office furniture, safes, barriers and the like.

The present coatings may be applied to structural steel, columns, beams, steel decking, bar joists, hung ceilings in commercial buildings, high-rise office buildings and apartment complexes, bridges and tunnels and the like.

In reference to steel and other metal substrates, such substrates may be primed metal, structural steel, aluminum, metal alloys, structural steel beams and columns, coil coating substrates, steel honeycomb structures in junction boxes, insulated steel, stainless steel piping, vessels and tanks.

The coatings of this invention are suitable for application masonry such as brick, concrete, cement block and platerboard.

Suitable wood substrates are for example dimensional lumber, plywood, particle board, OOSB board, unfinished interior wood, plywood acoustical board, insulation board, cellulose board, fiberboard, excelsior (wood wool), wood shavings, cedar shakes, unsheathed shingles, shakes, siding, telephone poles, posts, paper, paperboard, cardboard, corrugated sheets, etc.

The present flame retardant additives may be applied to wood as a stain component, as a sanding sealer component, as part of a topcoat, by pressure or vacuum impregnation or as saturants. The present flame retardant additives as applied to wood may be combined with a preservative; they may be incorporated into wood composite products during manufacture, by pressure impregnation, or may be applied as part of a paint or surface coating.

The present flame retardant additives as applied to paper may be sprayed on at the wet end of a paper machine or may be added in the size press or water boxes on the dry end; or may be applied with a coater or with a multi-station printing press.

The present coatings may further comprise foaming agents, blowing agents, charring agents and binding agents, thixotropic agents, spumific agents, dipentaerythritol and other additives for examples as disclosed in U.S. Pat. No. 5,723,515, the disclosure of which is hereby incorporated by reference.

Textiles are suitable coating substrates according to this invention, for example textile backcoatings, welding curtains, canopies, dividers, awnings, tents, nylon rope, netting, carpet backing, wall coverings, decorative products, natural fibers, synthetic fibers, upholster, carpeting, draperies, stage curtains, mattresses, hospital fabrics and woven and nonwoven fabrics.

The present coatings may be part of a composite construction with textile character, for example constructions which comprise a textile fabric and a polyolefin film coating and/or extrusion coating, for example as disclosed in U.S. Pat. No. 6,235,658, the disclosure of which is hereby incorporated by reference. The present coatings may be polyolefin coatings as disclosed in U.S. Pat. No. 6,251,995, the disclosure of which is hereby incorporated by reference.

The textile fabric may be woven, knitted or nonwoven fabrics based on polyethylene, polypropylene, polyethylene terephthalate, polyamide, cellulose or cotton. The polyolefin film or extrusion coating is for example about 3 to about 200 microns thick.

The instant invention also pertains to abrasion-resistant coating compositions suitable for coating over polycarbonates. Such coatings as described in U.S. Pat. No. 5,214,085 comprise a silyl acrylate, aqueous colloidal silica, a photoinitiator and optionally a polyfunctional acrylate as well as UV absorbers. Such present coatings, in addition to flame retardancy, provide resistance to degradation after prolonged outdoor exposure to sunlight, moisture and heat. Resistance is provided against yellowing, delamination and formation of microcracks and decreasing transparency.

Sealants and adhesives, for example sealant and adhesive layers, also fall under the present definition of “flame retardant coating”. For example, such as mastics, latex adhesives, binders, caulks, putties, mortars and sealants.

The present coatings may be layers of laminated articles, as film and/or as adhesive layers. For example, coatings and layers as disclosed in U.S. Pat. Nos. 6,187,845, 6,191,199 and 6,268,415, the disclosures of which are hereby incorporated by reference. Such coatings, films and adhesive layers are for example solar control films, films and glazings, UV absorbing glasses and glass coatings, windscreens, retroreflective sheetings and signs, solar reflectors, optical films and the like.

The present coatings are clear coats or are pigmented. They may be waterborne systems or solvent borne or may be a powder coating or a gel coat. They may be ambient cured, radiation cured (for example with the influence of a photoinitiator), oven cured or cured (crosslinked) with the aid of a catalyst, for example an acid catalyst.

The present coatings are based for example on alkyd resins; chlorinated alkyd resins; polyurethane resins; thermoplastic acrylic resins; acrylic alkyls; acrylic resins; latex emulsions; acrylic alkyd or polyester resins optionally modified with silicon, isocyanates, ketimines or oxazolidines; phenol-formaldehyde resins; resorcinol-formaldehyde resins; epoxy resins; epoxide resins crosslinked with carboxylic acids, anhydrides, polyamines or mercaptans; or acrylic and polyester resin systems modified with reactive groups in the backbone thereof and crosslinked with epoxide. For example, coatings based on resins of vinyl acetate-acrylate copolymer emulsions, solutions of vinyltoluene-2-ethylhexyl acrylate copolyers and polyurethane.

Epoxy binders are widely used in coatings and are suitable for the present invention. Epoxies are for example aliphatic, aromatic, cyclic, acyclic, alicyclic or heterocyclic. Such resins may be polyglycidyl ethers derived from such polyhydric alcohols as ethylene glycol, diethylene glycol, triethylene glycol, 1,2-propylene glycol, 1,4-butylene glycol, 1,5-pentanediol, 1,2,6-hexanetriol, glycerol, trimethylolpropane, bisphenol-A and bisphenol-F. Epoxide resins may also be polyglycidyl ethers of polycarboxylic acids, for example materials produced by the reaction of an epoxy compound such as epichlorohydrin with an aliphatic or aromatic polycarboxylic acid such as oxalic acid, succinic acid, glutaric acid, terephthalic acid, 2,6-naphthalene dicarboxylic acid and dimerized linoleic acid.

Epoxy resins are also derived from the epoxidation of an olefinically unsaturated alicyclic material. Among these are the epoxy alicyclic ethers and esters well known in the art. Epoxy resins also include those containing oxyalkylene groups. Such groups can be pendant from the backbone of the epoxide resin or they can be included as part of the backbone. The proportion of oxyalkylene groups in the epoxy resin depends upon a number of factors, among them the size of the oxyalkylene group and the nature of the epoxy resin.

Additionally, epoxy resins encompass the epoxy novolac resins. These resins are prepared by reacting an epihalohydrin with the condensation product of an aldehyde with a monohydric or polyhydric phenol. One example is the reaction product of epichlorhydrin with a phenol-formaldehyde condensate. A mixture of epoxy resins can also be use herein.

Materials such as epoxidized soybean oil, dimer acid based materials, such as EMPOL 1010 resin which is commericially available from Emery Chemicals, and rubber modified polyepoxide resins, such as the product prepared from a polyglycidyl ether of bisphenol A, e.g. EPON 828 from Shell Chemical, and an acid functional polybutadiene.

Crosslinkable polyurethanes, polyesters, polyvinyls, polysulfides, urea and formaldehyde are examples of resins which are suitable for this invention.

The instant invention also pertains to radiation-cured (UV-cured) coating systems using ethylenically unsaturated acrylic resins, polyurethane acrylates, epoxy acrylates, polyester acrylates, unsaturated polyester/styrene resins and silyl acrylates. The ethylenically unsaturated polymerizable compounds can contain one or more than one olefinic double bond. They may be low molecular (monomeric) or high molecular (oligomeric) compounds. Radiation cured coatings are described for example in U.S. application Ser. No. 09/794,710, filed Feb. 27, 2001, hereby incorporated by reference. Unsaturated monomers are typically alkyl- or hydroxyalkyl acrylates or methacrylates, styrene, ethylene glycol diacrylate, propylene glycol diacrylate, neopentyl glycol diacrylate, hexamethylene glycol diacrylate or bisphenol A diacrylate, 4,4′-bis(2-acryloyloxyethoxy)diphenylpropane, trimethylolpropane triacrylate, pentaerythritol triacrylate or tetraacrylate, styrene, hexamethylene glycol or bisphenol A diacrylate, 4,4′-bis(2-acryloyloxyethoxy)diphenylpropane or trimethylolpropane triacrylate. Oligomeric polyunsaturated compounds are for instance polyester acrylates or unsaturated polyester resins which are prepared from maleic acid, fumaric acid, phthalic acid and one or more than one diol, and which typically have molecular weights from about 500 to 3000. Unsaturated carboxylic acids are for example acrylic acid and methacrylic acid.

Powder coating compositions can be prepared by reacting glycidyl methacrylate with selected alcohol components.

The present coatings are for example enamels with high solids content based on crosslinkable acrylic, polyester, urethane, or alkyd resins cured with an additional acid catalyst. These acid catalyzed stoving lacquers are based for example on hot crosslinkable acrylic, polyester, polyurethane, polyamide or alkyd resins.

The present coatings may be a multi-layer system, for example the flame retardant additive combinations of this invention may be present in one or more than one layer of a multi-layer coating system.

The present coatings may be applied to the substrate by any conventional manner, for example by brush, roller, spray, dipping, electrostatic deposition, extrusion/coextrusion, troweling (mastics) and the like.

The present coatings may be intumescent or non-intumescent.

The present coatings are of course, thin layers. They are for example from about 5 microns to about 10 mil thick, for instance from about 10 microns to about 7 mil thick, or from about 1 mil to about 5 mil thick. They are for instance about 10 microns, or about 1, 2, 3, 4, 5 or 6 mil thick. There are 26 microns per mil.

The present coatings are themselves flame retardant and provide flame retardancy to the entire article of which they are a part (for instance a coated plastic part).

Sterically Hindered Compounds of Component (i)

The present sterically hindered stabilizers of component (i) are well known in the art, and are for example of the formula 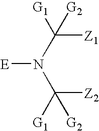
where

G₁ and G₂ are independently alkyl of 1 to 8 carbon atoms or are together pentamethylene,

Z₁ and Z₂ are each methyl, or Z₁ and Z₂ together form a linking moiety which may additionally be substituted by an ester, ether, amide, amino, carboxy or urethane group, and

E is oxyl, hydroxyl, alkoxy, cycloalkoxy, aralkoxy, aryloxy, —O—CO—OZ₃, —O—Si(Z₄)₃, —O—PO(OZ₅)₂ or —O—CH₂—OZ₆ where Z₃, Z₄, Z₅ and Z₆ are selected from the group consisting of hydrogen, an aliphatic, araliphatic and aromatic moiety; or E is —O-T-(OH)_{b},

T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;

b is 1, 2 or 3 with the proviso that b cannot exceed the number of carbon atoms in T, and when b is 2 or 3, each hydroxyl group is attached to a different carbon atoms of T.

E is for example oxyl, hydroxyl, alkoxy, cycloalkoxy or aralkoxy. For instance, E is methoxy, propoxy, cyclohexyloxy or octyloxy.

The present sterically hindered stabilizers of component (i) are for example of the formula A-R 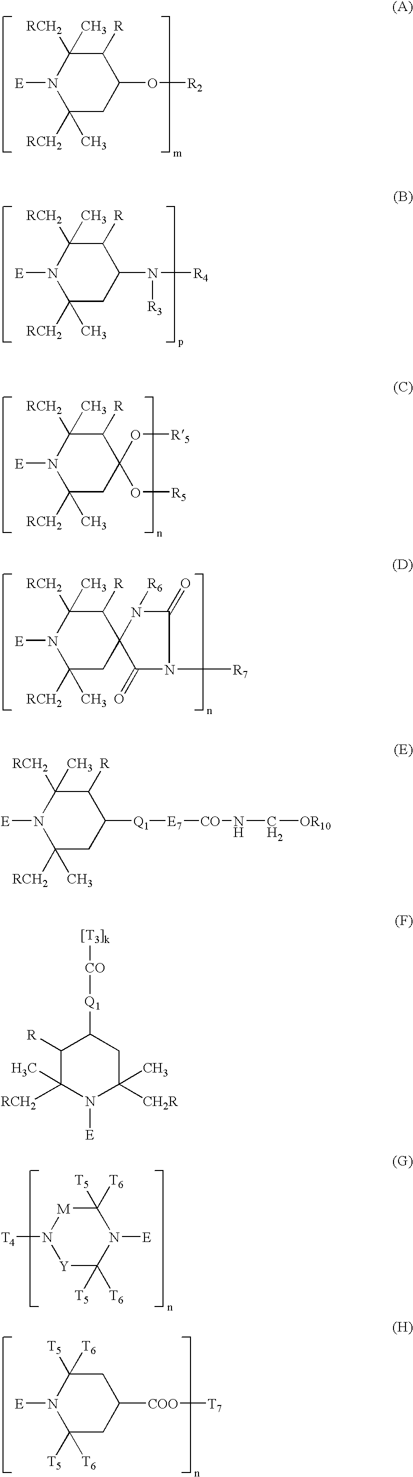 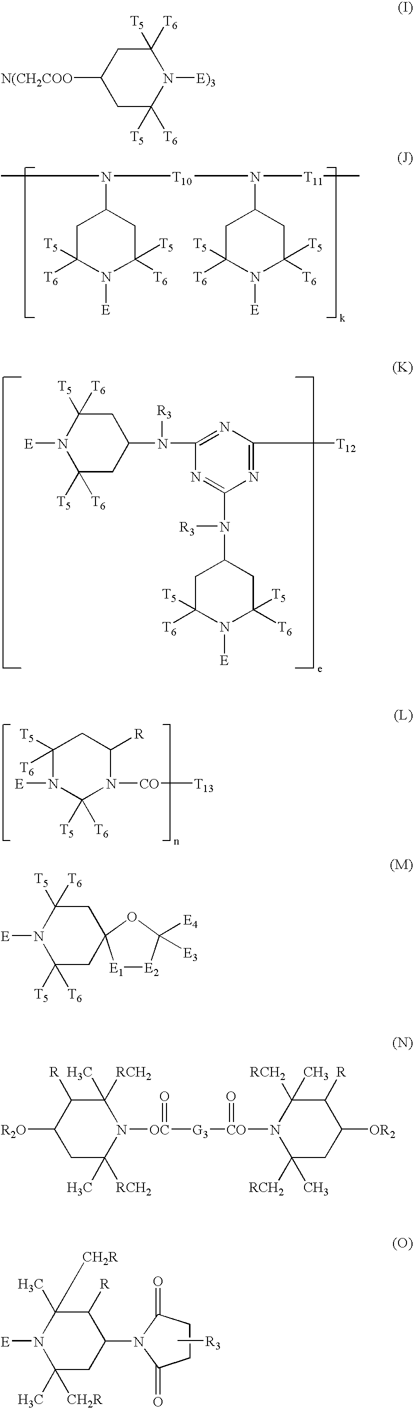 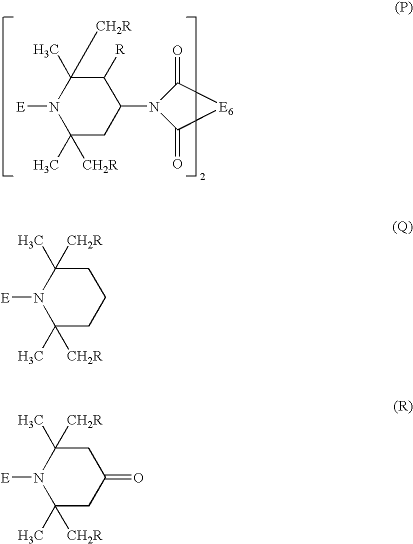
wherein

E is oxyl, hydroxyl, alkoxy of 1 to 18 carbon atoms, cycloalkoxy of 5 to 12 carbon atoms or aralkoxy of 7 to 15 carbon atoms, or E is —O-T-(OH)_{b},

T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;

b is 1, 2 or 3 with the proviso that b cannot exceed the number of carbon atoms in T, and when b is 2 or 3, each hydroxyl group is attached to a different carbon atoms of T;

R is hydrogen or methyl,

m is 1 to 4,

when m is 1,

R₂ is hydrogen, C₁-C₁₈alkyl or said alkyl optionally interrupted by one or more oxygen atoms, C₂-C₁₂alkenyl, C₆-C₁₀aryl, C₇-C₁₈aralkyl, glycidyl, a monovalent acyl radical of an aliphatic, cycloaliphatic or aromatic carboxylic acid, or a carbamic acid, for example an acyl radical of an aliphatic carboxylic acid having 2-18 C atoms, of a cycloaliphatic carboxylic acid having 5-12 C atoms or of an aromatic carboxylic acid having 7-15 C atoms, or 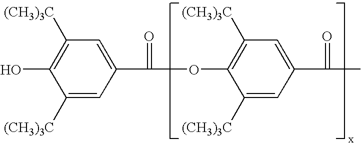
wherein x is 0 or 1, 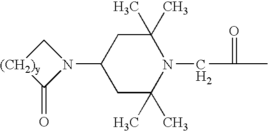
wherein y is 2-4;

when m is 2,

R₂ is C₁-C₁₂alkylene, C₄-C₁₂alkenylene, xylylene, a divalent acyl radical of an aliphatic, cycloaliphatic, araliphatic or aromatic dicarboxylic acid or of a dicarbamic acid, for example an acyl radical of an aliphatic dicarboxylic acid having 2-18 C atoms, of a cycloaliphatic or aromatic dicarboxylic acid having 8-14 C atoms, or of an aliphatic, cycloaliphatic or aromatic dicarbamic acid having 8-14 C atoms; 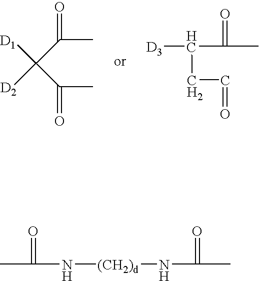
wherein D₁ and D₂ are independently hydrogen, an alkyl radical containing up to 8 carbon atoms, an aryl or aralkyl radical including 3,5-di-t-butyl-4-hydroxybenzyl radical, D₃ is hydrogen, or an alkyl or alkenyl radical containing up to 18 carbon atoms, and d is 0-20;

when m is 3, R₂ is a trivalent acyl radical of an aliphatic, unsaturated aliphatic, cycloaliphatic, or aromatic tricarboxylic acid;

when m is 4, R₂ is a tetravalent acyl radical of a saturated or unsaturated aliphatic or aromatic tetracarboxylic acid including 1,2,3,4-butanetetracarboxylic acid, 1,2,3,4-but-2-ene-tetracarboxylic, and 1,2,3,5- and 1,2,4,5-pentanetetracarboxylic acid;

p is 1, 2 or 3,

R₃ is hydrogen, C₁-C₁₂alkyl, C₅-C₇cycloalkyl, C₇-C₉aralkyl, C₂-C₁₈alkanoyl, C₃-C₅alkenoyl or benzoyl;

when p is 1,

R₄ is hydrogen, C₁-C₁₈alkyl, C₅-C₇cycloalkyl, C₂-C₈alkenyl, unsubstituted or substituted by a cyano, carbonyl or carbamide group, aryl, aralkyl, or it is glycidyl, a group of the formula —CH₂—CH(OH)-Z or of the formula —CO-Z or —CONH-Z wherein Z is hydrogen, methyl or phenyl; or a group of the formulae 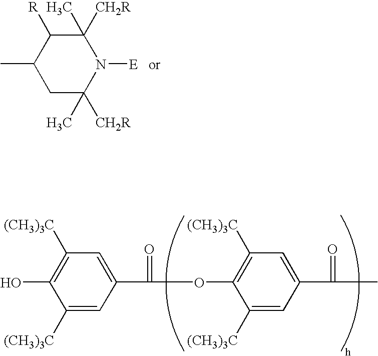
where h is 0 or 1,

R₃ and R4 together, when p is 1, can be alkylene of 4 to 6 carbon atoms or 2-oxo-polyalkylene the cyclic acyl radical of an aliphatic or aromatic 1,2- or 1,3-dicarboxylic acid,

when p is 2,

R₄ is a direct bond or is C₁-C₁₂alkylene, C₆-C₁₂arylene, xylylene, a —CH₂CH(OH)—CH₂ group or a group —CH₂—CH(OH)—CH₂—O—X—O—CH₂—CH(OH)—CH₂— wherein X is C₂-C₁₀alkylene, C₆-C₁₅arylene or C₆-C₁₂cycloalkylene; or, provided that R₃ is not alkanoyl, alkenoyl or benzoyl, R₄ can also be a divalent acyl radical of an aliphatic, cycloaliphatic or aromatic dicarboxylic acid or dicarbamic acid, or can be the group —CO—; or

R₄ is

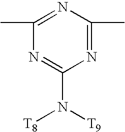

where T₈ and T₉ are independently hydrogen, alkyl of 1 to 18 carbon atoms, or T₈ and T₉ together are alkylene of 4 to 6 carbon atoms or 3-oxapentamethylene, for instance T₈ and T₉ together are 3-oxapentamethylene;

when p is 3,

R₄ is 2,4,6-triazinyl,

n is 1 or 2,

when n is 1,

R₅ and R′₅ are independently C₁-C₁₂ alkyl, C₂-C₁₂ alkenyl, C₇-C₁₂ aralkyl, or R₅ is also hydrogen, or R₅ and R′₅ together are C₂-C₈alkylene or hydroxyalkylene or C₄-C₂₂acyloxyalkylene;

when n is 2,

R₅ and R′₅ together are (—CH₂)₂C(CH₂—)₂;

R₆ is hydrogen, C₁-C₁₂alkyl, allyl, benzyl, glycidyl or C₂-C₆alkoxyalkyl;

when n is 1,

R₇ is hydrogen, C₁-C₁₂alkyl, C₃-C₅alkenyl, C₇-C₉aralkyl, C₅-C₇cycloalkyl, C₂-C₄hydroxyalkyl, C₂-C₆alkoxyalkyl, C₆-C₁₀ aryl, glycidyl, a group of the formula —(CH₂)ₜ—COO-Q or of the formula —(CH₂)ₜ—O—CO-Q wherein t is 1 or 2, and Q is C₁-C₄alkyl or phenyl; or

when n is 2,

R₇ is C₂-C₁₂alkylene, C₆-C₁₂arylene, a group —CH₂CH(OH)—CH₂—O—X—O—CH₂—CH(OH)—CH₂— wherein X is C₂-C₁₀alkylene, C₆-C₁₅arylene or C₆-C₁₂cycloalkylene, or a group —CH₂CH(OZ′)CH₂—(OCH₂—CH(OZ′)CH₂)₂— wherein Z′ is hydrogen, C₁-C₁₈alkyl, allyl, benzyl, C₂-C₁₂alkanoyl or benzoyl;

Q₁ is —N(R₈)— or —O—; E₇ is C₁-C₃ alkylene, the group —CH₂—CH(R₉)—O— wherein R₉ is hydrogen, methyl or phenyl, the group —(CH₂)₃—NH— or a direct bond;

R₁₀ is hydrogen or C₁-C₁₈ alkyl, R₈ is hydrogen, C₁-C₁₈alkyl, C₅-C₇cycloalkyl, C₇-C₁₂aralkyl, cyanoethyl, C₆-C₁₀aryl, the group —CH₂—CH(R₉)—OH wherein R₉ has the meaning defined above; a group of the formula 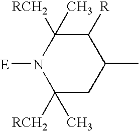
or a group of the formula

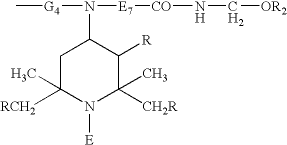

wherein G₄ is C₂-C₆alkylene or C₆-C₁₂arylene; or R₈ is a group -E₇-CO—NH—CH₂—OR₁₀;

Formula F denotes a recurring structural unit of a polymer where T₃ is ethylene or 1,2-propylene, is the repeating structural unit derived from an alpha-olefin copolymer with an alkyl acrylate or methacrylate; for example a copolymer of ethylene and ethyl acrylate, and where k is 2 to 100;

T₄ has the same meaning as R₄ when p is 1 or 2,

T₅ is methyl,

T₆ is methyl or ethyl, or T₅ and T₆ together are tetramethylene or pentamethylene, for instance T₅ and T₆ are each methyl,

M and Y are independently methylene or carbonyl, and T₄ is ethylene where n is 2;

T₇ is the same as R₇, and T₇ is for example octamethylene where n is 2,

T₁₀ and T₁₁ are independently alkylene of 2 to 12 carbon atoms, or T₁₁ is

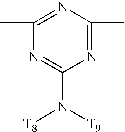

T₁₂ is piperazinyl,

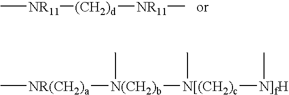

where R₁₁ is the same as R₃ or is also

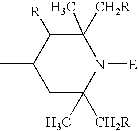

a, b and c are independently 2 or 3, and f is 0 or 1, for instance a and c are each 3, b is 2 and f is 1; and

e is 2, 3 or 4, for example 4;

T₁₃ is the same as R₂ with the proviso that T₁₃ cannot be hydrogen when n is 1;

E₁ and E₂, being different, each are —CO— or —N(E₅)- where E₅ is hydrogen, C₁-C₁₂ alkyl or C₄-C₂₂ alkoxycarbonylalkyl, for instance E₁ is —CO— and E₂ is —N(E₅)-,

E₃ is hydrogen, alkyl of 1 to 30 carbon atoms, phenyl, naphthyl, said phenyl or said naphthyl substituted by chlorine or by alkyl of 1 to 4 carbon atoms, or phenylalkyl of 7 to 12 carbon atoms, or said phenylalkyl substituted by alkyl of 1 to 4 carbon atoms,

E₄ is hydrogen, alkyl of 1 to 30 carbon atoms, phenyl, naphthyl or phenylalkyl of 7 to 12 carbon atoms, or

E₃ and E₄ together are polymethylene of 4 to 17 carbon atoms, or said polymethylene substituted by up to four alkyl groups of 1 to 4 carbon atoms, for example methyl,

E₆ is an aliphatic or aromatic tetravalent radical,

R₂ of formula (N) is a previously defined when m is 1;

G₁ a direct bond, C₁-C₁₂ alkylene, phenylene or —NH-G′-NH wherein G′ is C₁-C₁₂ alkylene; or

wherein the hindered amine compound is a compound of the formula I, II, III, IV, V, VI, VII, VIII, IX, X or XI 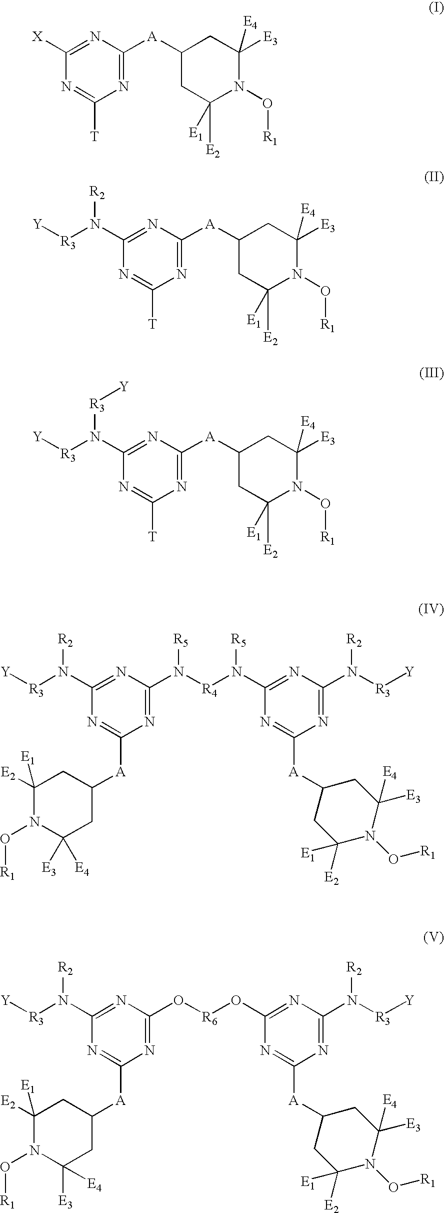 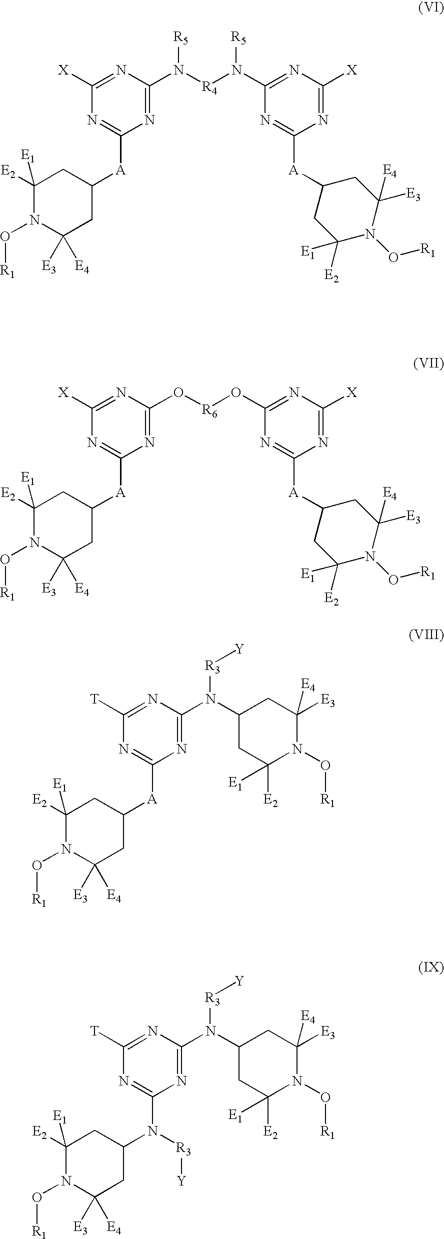 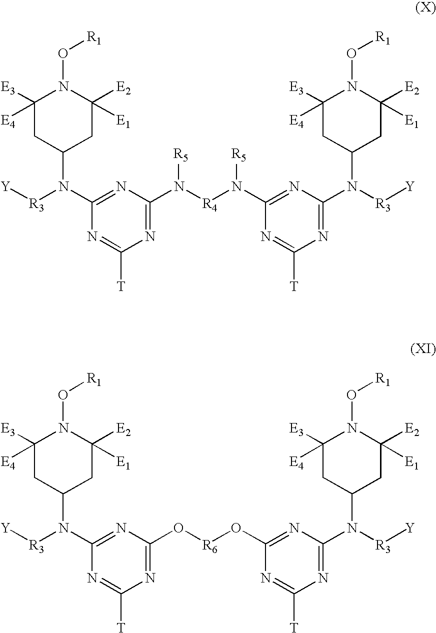
wherein

E₁, E₂, E₃ and E₄ are independently alkyl of 1 to 4 carbon atoms, or E₁ and E₂ are independently alkyl of 1 to 4 carbon atoms and E₃ and E₄ taken together are pentamethylene, or E₁ and E₂; and E₃ and E₄ each taken together are pentamethylene,

R₁ is alkyl of 1 to 18 carbon atoms, cycloalkyl of 5 to 12 carbon atoms, a bicyclic or tricyclic hydrocarbon radical of 7 to 12 carbon atoms, phenylalkyl of 7 to 15 carbon atoms, aryl of 6 to 10 carbon atoms or said aryl substituted by one to three alkyl of 1 to 8 carbon atoms,

R₂ is hydrogen or a linear or branched chain alkyl of 1 to 12 carbon atoms,

R₃ is alkylene of 1 to 8 carbon atoms, or R₃ is —CO—, —CO-R₄—, —CONR₂—, or —CO—NR₂—R₄—,

R₄ is alkylene of 1 to 8 carbon atoms,

R₅ is hydrogen, a linear or branched chain alkyl of 1 to 12 carbon atoms, or

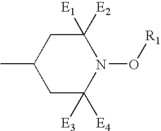

or when R₄ is ethylene, two R₅ methyl substituents can be linked by a direct bond so that the triazine bridging group —N(R₅)—R₄—N(R₅)— is a piperazin-1,4-diyl moiety,

R₆ is alkylene of 2 to 8 carbon atoms or R₆ is 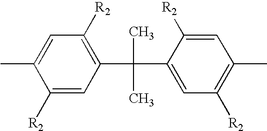
with the proviso that Y is not —OH when R₆ is the structure depicted above,

A is —O— or —NR₇— where R₇ is hydrogen, a straight or branched chain alkyl of 1 to 12 carbon atoms, or R₇ is

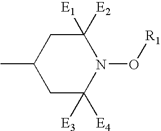

T is phenoxy, phenoxy substituted by one or two alkyl groups of 1 to 4 carbon atoms, alkoxy of 1 to 8 carbon atoms or —N(R₂)₂ with the stipulation that R₂ is not hydrogen, or T is

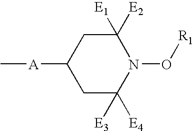

X is —NH₂, —NCO, —OH, —O-glycidyl, or —NHNH₂, and

Y is —OH, —NH₂, —NHR₂ where R₂ is not hydrogen; or Y is —NCO, —COOH, oxiranyl, —O— glycidyl, or —Si(OR₂)₃; or the combination R₃—Y— is —CH₂CH(OH)R₂ where R₂ is alkyl or said alkyl interrupted by one to four oxygen atoms, or R₃—Y— is —CH₂OR₂; or wherein the hindered amine compound is a mixture of N,N′,N′″-tris{2,4-bis[(1-hydrocarbyloxy-2,2,6,6-tetramethylpiperidin-4-yl)alkylamino]-s-triazin-6-yl}-3,3′-ethylenediiminodipropylamine; N,N′,N″-tris{2,4-bis[(1-hydrocarbyloxy-2,2,6,6-tetramethylpiperidin-4-yl)alkylamino]-s-triazin-6-yl}-3,3′-ethylenediiminodipropylamine, and bridged derivatives as described by formulas I, II, IIA and III
R₁NH—CH₂CH₂CH₂NR₂CH₂CH₂NR₃CH₂CH₂CH₂NHR₄ (I)
T-E₁-T₁ (II)
T-E₁ (IIA)
G-E₁-G₁-E₁-G₂ (III)
where in the tetraamine of formula I

R₁ and R₂ are the s-triazine moiety E; and one of R₃ and R₄ is the s-triazine moiety E with the other of R₃ or R₄ being hydrogen,
E is

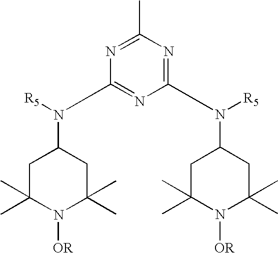

R is methyl, propyl, cyclohexyl or octyl, for instance cyclohexyl,

R₅ is alkyl of 1 to 12 carbon atoms, for example n-butyl, where in the compound of formula II or IIA when R is propyl, cyclohexyl or octyl,

T and T₁ are each a tetraamine substituted by R₁-R₄ as is defined for formula I, where

(1) one of the s-triazine moieties E in each tetraamine is replaced by the group E₁ which forms a bridge between two tetraamines T and T₁,

E₁ is 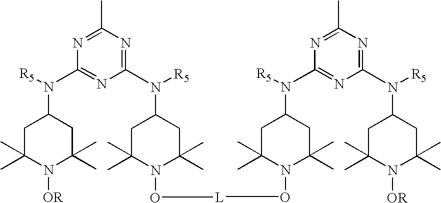
or

(2) the group E₁ can have both termini in the same tetraamine T as in formula IIA where two of the E moieties of the tetraamine are replaced by one E₁ group, or

(3) all three s-triazine substituents of tetraamine T can be E₁ such that one E₁ links T and T₁ and a second E₁ has both termini in tetraamine T,

L is propanediyl, cyclohexanediyl or octanediyl; where in the compound of formula III

G, G₁ and G₂ are each tetraamines substituted by R₁-R₄ as defined for formula I, except that G and G₂ each have one of the s-triazine moieties E replaced by E₁, and G₁ has two of the triazine moieties E replaced by E₁, so that there is a bridge between G and G₁ and a second bridge between G₁ and G₂;

which mixture is prepared by reacting two to four equivalents of 2,4-bis[(1-hydrocarbyloxy-2,2,6,6-piperidin-4-yl)butylamino]-6-chloro-s-triazine with one equivalent of N,N′-bis(3-amino-propyl)ethylenediamine;
or the hindered amine is a compound of the formula IIIb

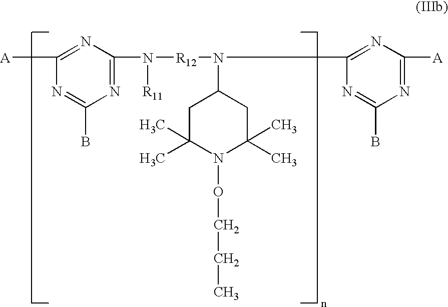

in which the index n ranges from 1 to 15;

R₁₂ is C₂-C₁₂alkylene, C₄-C₁₂alkenylene, C₅-C₇cycloalkylene, C₅-C₇cycloalkylene-di(C₁-C₄alkylene), C₁-C₄alkylenedi(C₅-C₇cycloalkylene), phenylenedi(C₁-C₄alkylene) or C₄-C₁₂alkylene interrupted by 1,4-piperazinediyl, —O— or>N—X₁ with X₁ being C₁-C₁₂acyl or (C₁-C₁₂alkoxy)carbonyl or having one of the definitions of R₁₄ given below except hydrogen; or R₁₂ is a group of the formula (Ib′) or (Ic′);

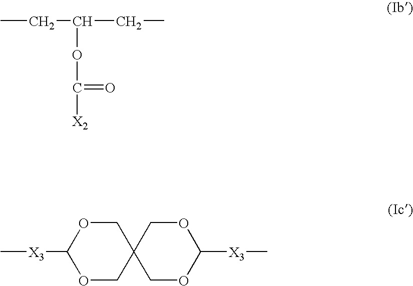

with m being 2 or 3,

X₂ being C₁-C₁₈alkyl, C₅-C₁₂cycloalkyl which is unsubstituted or substituted by 1, 2 or 3 C₁-C₄alkyl; phenyl which is unsubstituted or substituted by 1, 2 or 3 C₁-C₄alkyl or C₁-C₄alkoxy; C₇-C₉phenylalkyl which is unsubstituted or substituted on the phenyl by 1, 2 or 3 C₁-C₄alkyl; and

the radicals X₃ being independently of one another C₂-C₁₂alkylene;

R₁₃, R₁₄ and R₁₅, which are identical or different, are hydrogen, C₁-C₁₈alkyl, C₅-C₁₂cycloalkyl which is unsubstituted or substituted by 1, 2 or 3 C₁-C₄alkyl; C₃-C₁₈alkenyl, phenyl which is unsubstituted or substituted by 1, 2 or 3 C₁-C₄alkyl or C₁-C₄alkoxy; C₇-C₉phenylalkyl which is unsubstituted or substituted on the phenyl by 1, 2 or 3 C₁-C₄alkyl; tetrahydrofurfuryl or C₂-C₄alkyl which is substituted in the 2, 3 or 4 position by —OH, C₁-C₈alkoxy, di(C₁-C₄alkyl)amino or a group of the formula (Ie′);

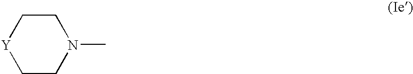

with Y being —O—, —CH₂—, —CH₂CH₂— or>N—CH₃,

or —N(R₁₄)(R₁₅) is additionally a group of the formula (Ie′);

the radicals A are independently of one another —OR₁₃, —N(R₁₄)(R₁₅) or a group of the formula (IIId);

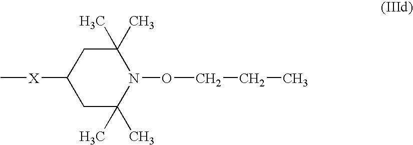

X is —O— or>N—R₁₆;

R₁₆ is hydrogen, C₁-C₁₈alkyl, C₃-C₁₈alkenyl, C₅-C₁₂cycloalkyl which is unsubstituted or substituted by 1, 2 or 3 C₁-C₄alkyl; C₇-C₉phenylalkyl which is unsubstituted or substituted on the phenyl by 1, 2 or 3 C₁-C₄alkyl; tetrahydrofurfuryl, a group of the formula (IIIf), 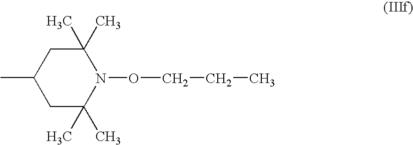
or C₂-C₄alkyl which is substituted in the 2, 3 or 4 position by —OH, C₁-C₈alkoxy, di(C₁-C₄alkyl)amino or a group of the formula (Ie′);

R₁₁ has one of the definitions given for R₁₆; and

the radicals B have independently of one another one of the definitions given for A.

If R₂ is a monovalent acyl radical of a carboxylic acid, it is for example an acyl radical of acetic acid, stearic acid, salicyclic acid, benzoic acid or β-(3,5-di-tert-butyl-4-hydroxyphenyl) propionic acid.

If R₂ is a divalent acyl radical of a dicarboxylic acid, it is for example an acyl radical of oxalic acid, adipic acid, succinic acid, suberic acid, sebacic acid, phthalic acid dibutylmalonic acid, dibenzylmalonic acid or butyl-(3,5-di-tert-butyl-4-hydropxybenzyl)-malonic acid, or bicycloheptenedicarboxylic acid, with succinates, sebacates, phthalates and isophthalates being specific examples.

If R₂ is a divalent acyl radical of a dicarbamic acid, it is for example an acyl radical of hexamethylenedicarbamic acid or of 2,4-toluylenedicarbamic acid.

The hindered alkoxyamine stabilizers of component (c) are well known in the art, also known as N-alkoxy hindered amines and NOR hindered amines or NOR hindered amine light stabilizers or NOR HALS.

They are disclosed for example in U.S. Pat. Nos. 5,004,770, 5,204,473, 5,096,950, 5,300,544, 5,112,890, 5,124,378, 5,145,893, 5,216,156, 5,844,026, 5,439,958, 5,021,481, 6,117,995, 6,271,377, and U.S. application Ser. No. 09/505,529, filed Feb. 17, 2000, Ser. No. 09/794,710, filed Feb. 27, 2001, Ser. No. 09/714,717, filed Nov. 16, 2000, Ser. No. 09/502,239, filed Nov. 3, 1999 and 60/312,517, filed Aug. 15, 2001. The relevant disclosures of these patents and applications are hereby incorporated by reference.

U.S. Pat. No. 6,271,377, and U.S. application Ser. No. 09/505,529, filed Feb. 17, 2000, and Ser. No. 09/794,710, filed Feb. 27, 2001, cited above disclose hindered hydroxyalkoxyamine stabilizers. For the purposes of this invention, the hindered hydoxyalkoxyamine stabilizers are considered a subset of the hindered alkoxyamine stabilizers and are part of present component (c). Hindered hydroxyalkoxyamine stabilizers are also known as N-hydroxyalkoxy hindered amines, or NORol HALS.

Typical nitroxyls of component (a) include bis(1-oxyl-2,2,6,6-tetramethylpiperidin-4-yl) sebacate, 4-hydroxy-1-oxyl-2,2,6,6-tetramethylpiperidine, 4-ethoxy-1-oxyl-2,2,6,6-tetramethylpiperidine, 4-propoxy-1-oxyl-2,2,6,6-tetramethylpiperidine, 4-acetamido-1-oxyl-2,2,6,6-tetramethylpiperidine, 1-oxyl-2,2,6,6-tetramethylpiperidine, 1-oxyl-2,2,6,6-tetramethylpiperidin-4-one, 1-oxyl-2,2,6,6-tetramethylpiperidin-4-yl acetate, 1-oxyl-2,2,6,6-tetramethylpiperidin-4-yl 2-ethylhexanoate, 1-oxyl-2,2,6,6-tetramethylpiperidin-4-yl stearate, 1-oxyl-2,2,6,6-tetramethylpiperidin-4-yl benzoate, 1-oxyl-2,2,6,6-tetramethylpiperidin-4-yl 4-t-butyl-benzoate, bis(1-oxyl-2,2,6,6-tetramethylpiperidin-4-yl)succinate, bis(1-oxyl-2,2,6,6-tetramethylpiperidin-4-yl)adipate, bis(1-oxyl-2,2,6,6-tetramethylpiperidin-4-yl)n-butylmalonate, bis(1-oxyl-2,2,6,6-tetramethylpiperidin-4-yl)phthalate, bis(1-oxyl-2,2,6,6-tetramethylpiperidin-4-yl)isophthalate, bis(1-oxyl-2,2,6,6-tetramethylpiperidin-4-yl)terephthalate, bis(1-oxyl-2,2,6,6-tetramethylpiperidin-4-yl)hexahydroterephthalate, N,N′-bis(1-oxyl-2,2,6,6-tetramethylpiperidin-4-yl)adipamide, N-(1-oxyl-2,2,6,6-tetramethylpiperidin-4-yl)caprolactam, N-(1-oxyl-2,2,6,6-tetramethylpiperidin-4-yl)dodecylsuccinimide, 2,4,6-tris-[N-butyl-N-(1-oxyl-2,2,6,6-tetramethylpiperidin-4-yl)]-s-triazine, 4,4′-ethylenebis(1-oxyl-2,2,6,6-tetramethylpiperazin-3-one), 2-oxyl-1,1,3,3-tetramethyl-2-isobenzazole, 1-oxyl-2,2,5,5-tetramethylpyrrolidine, and N,N-bis-(1,1,3,3-tetramethylbutyl)nitroxide.

Nitroxyl stabilizers of component (a) are for example bis(1-oxyl-2,2,6,6-tetramethylpiperidin-4-yl)sebacate, 4-hydroxy-1-oxyl-2,2,6,6-tetramethylpiperidine, 4-ethoxy-1-oxyl-2,2,6,6-tetramethylpiperidine, 4-propoxy-1-oxyl-2,2,6,6-tetramethylpiperidine, 4-acetamido-1-oxyl-2,2,6,6-tetramethylpiperidine, 1-oxyl-2,2,6,6-tetramethylpiperidine, and 1-oxyl-2,2,6,6-tetramethylpiperidin-4-one.

A specific embodiment is where the nitroxyl stabilizers of component (a) are bis(1-oxyl-2,2,6,6-tetramethylpiperidin-4-yl)sebacate and 4-hydroxy-1-oxyl-2,2,6,6-tetramethylpiperidine.

Hydroxylamine stabilizers of component (b) are for example those disclosed in U.S. Pat. Nos. 4,831,134, 4,590,231, 4,668,721, 4,691,015, 4,831,134, 5,006,577, and 5,064,883, the relevant parts of which are incorporated herein by reference.

Specific examples of suitable compounds of present component (i) include:

(a) the reaction product of 2,4-bis[(1-cyclohexyloxy-2,2,6,6-piperidin-4-yl)butylamino]-6-chloro-s-triazine with N,N′-bis(3-aminopropyl)ethylenediamine) [CAS Reg. No. 191680-81-6];
(b) 1-cyclohexyloxy-2,2,6,6-tetramethyl-4-octadecylaminopiperidine;
(c) bis(1-octyloxy-2,2,6,6-tetramethylpiperidin-4-yl)sebacate;
(d) 2,4-bis[(1-cyclohexyloxy-2,2,6,6-tetramethylpiperidin-4-yl)butylamino]-6-(2-hydroxy-ethylamino-s-triazine;
(e) bis(1-cyclohexyloxy-2,2,6,6-tetramethylpiperidin-4-yl)adipate;
(h) 2,4-bis[(1-cyclohexyloxy-2,2,6,6-piperidin-4-yl)butylamino]-6-chloro-s-triazine;
(i) 1-(2-hydroxy-2-methylpropoxy)-4-hydroxy-2,2,6,6-tetramethylpiperidine;
(j) 1-(2-hydroxy-2-methylpropoxy)-4-oxo-2,2,6,6-tetramethylpiperidine;
(k) 1-(2-hydroxy-2-methylpropoxy)-4-octadecanoyloxy-2,2,6,6-tetramethylpiperidine;
(l) bis(1-(2-hydroxy-2-methylpropoxy)-2,2,6,6-tetramethylpiperidin-4-yl)sebacate;
(m) bis(1-(2-hydroxy-2-methylpropoxy)-2,2,6,6-tetramethylpiperidin-4-yl)adipate;
(n) 2,4-bis{N-[1-(2-hydroxy-2-methylpropoxy)-2,2,6,6-tetramethylpiperidin-4-yl]-N-butyl-amino}-6-(2-hydroxyethylamino)-s-triazine; and
(o) the compound of formula 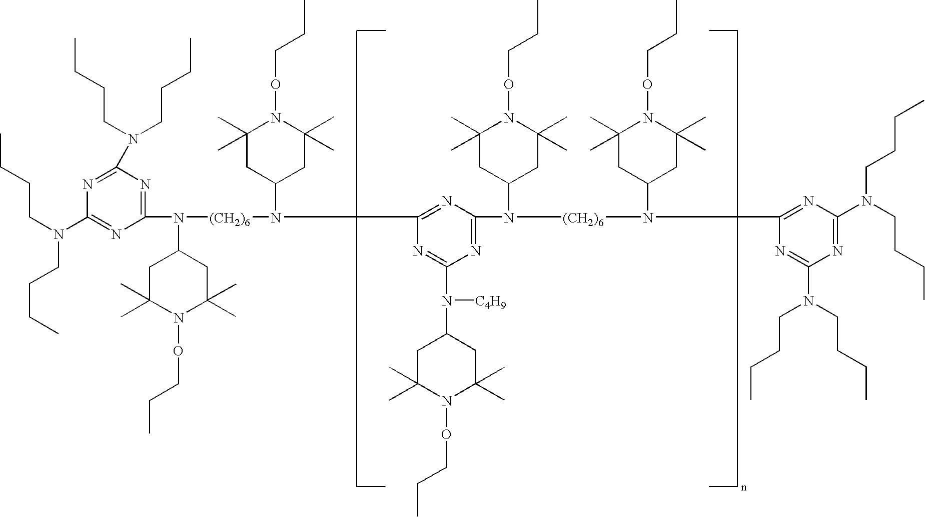
   in which n is from 1 to 15.

Compound (o) is disclosed in example 2 of U.S. Pat. No. 6,117,995.

The sterically hindered alkoxyamine or hydroxyalkoxyamine is for example the reaction product of 2,4-bis[(1-cyclohexyloxy-2,2,6,6-piperidin-4-yl)butylamino]-6-chloro-s-triazine with N,N′-bis(3-aminopropyl)ethylenediamine) [CAS Reg. No. 191680-81-6]; bis(1-octyloxy-2,2,6,6-tetramethylpiperidin-4-yl)sebacate; or the compounds (i), (j), (k) or (o); or mixtures of said hindered alkoxyamines and hydroxyalkoxyamines.

Alkyl is a straight or branched chain and is for example methyl, ethyl, n-propyl, n-butyl, sec-butyl, tert-butyl, n-hexyl, n-octyl, 2-ethylhexyl, n-nonyl, n-decyl, n-undecyl, n-dodecyl, n-tridecyl, n-tetradecyl, n-hexadecyl or n-octadecyl.

Cycloalkyl groups are for example of from 5 to 7 carbon atoms and include cyclopentyl and cyclohexyl; typical cycloalkenyl groups include cyclohexenyl.

Aralkyl groups include for example benzyl, alpha-methyl-benzyl, alpha,alpha-dimethylbenzyl or phenethyl.

Aryl is for instance phenyl, napthyl and biphenyl.

Alkoxy, aryloxy and cycloalkoxy groups are defined as for the present alkyl, aryl and cycloalkyl groups.

Halogen is for instance chloro and bromo.

Conventional Flame Retardants

Oganohalogen flame retardants are for example:

Chloroalkyl phosphate esters (ANTIBLAZE® AB-100, Albright & Wilson; FYROL® FR-2, Akzo Nobel),

tris(2-chloroethyl)phosphate

polybrominated diphenyl oxide (DE-60F, Great Lakes Corp.),

decabromodiphenyl oxide (DBDPO; SAYTEX® 102E),

tris[3-bromo-2,2-bis(bromomethyl)propyl]phosphate (PB 370®, FMC Corp.),

tris(2,3-dibromopropyl)phosphate

tris(2,3-dichloropropyl)phosphate,

chlorendic acid,

tetrachlorophthalic acid,

tetrabromophthalic acid,

bis-(N,N′-hydroxyethyl)tetrachlorphenylene diamine,

poly-β-chloroethyl triphosponate mixture

bis(2,3-dibromopropyl ether) of bisphenol A (PE68),

brominated epoxy resin,

ethylene-bis(tetrabromophthalimide) (SAYTEX® BT-93),

bis(hexachlorocyclopentadieno)cyclooctane (DECLORANE PLUS®),

chlorinated paraffins,

octabromodiphenyl ether,

hexachlorocyclopentadiene derivatives,

1,2-bis(tribromophenoxy)ethane (FF680),

tetrabromo-bisphenol A (SAYTEX® RB100),

ethylene bis-(dibromo-norbornanedicarboximide) (SAYTEX® BN-451),

bis-(hexachlorocyclopentadieno)cyclooctane,

PTFE

tris-(2,3-dibromopropyl)-isocyanurate, and

ethylene-bis-tetrabromophthalimide.

The organophophorus flame retardants are for example:

Tetraphenyl resorcinol diphosphite (FYROLFLEX® RDP, Akzo Nobel),

triphenyl phosphate,

trioctyl phosphate,

tricresyl phosphate,

tetrakis(hydroxymethyl)phosphonium sulfide,

diethyl-N,N-bis(2-hydroxyethyl)-aminomethyl phosphonate,

hydroxyalkyl esters of phosphorus acids,

ammonium polyphosphate (APP) or (HOSTAFLAM® AP750),

resorcinol diphosphate oligomer (RDP),

phosphazene flame retardants and

ethylenediamine diphosphate (EDAP).

Isocyanurate flame retardants include polyisocyanurate, esters of isocyanuric acid and isocyanurates. For example, an hydroxyalkyl isocyanurate such as tris-(2-hydroxyethyl)isocyanurate, tris(hydroxymethyl)isocyanurate, tris(3-hydroxy-n-proyl)isocyanurate or triglycidyl isocyanurate.

The melamine based flame retardants are for example:

melamine cyanurate,

melamine borate,

melamine phosphates,

melamine polyphosphates and

melamine pyrophosphates.

Boric acid may be included as a flame retardant.

The halogenated flame retardants useful in the present invention may be selected from organic aromatic halogenated compounds such as halogenated benzenes, biphenyls, phenols, ethers or esters thereof, bisphenols, diphenyloxides, aromatic carboxylic acids or polyacids, anhydrides, amides or imides thereof; organic cycloaliphatic or polycycloaliphatic halogenated compounds; and organic aliphatic halogenated compounds such as halogenated paraffins, oligo- or polymers, alkylphosphates or alkylisocyanurates. These components are largely known in the art, see e.g. U.S. Pat. No. 4,579,906 (e.g. col. 3, lines 30-41), U.S. Pat. No. 5,393,812; see also Plastics Additives Handbook, Ed. by H. Zweifel, 5^{th} Ed., Hanser Publ., Munich 2001, pp. 681-698.

The phosphazene flame retardants are well known in the art. They are disclosed for example in EP1104766, JP07292233, DE19828541, DE1988536, JP11263885, U.S. Pat. Nos. 4,107,108, 4,108,805 and 4,079,035 and 6,265,599. The relevant disclosures of the U.S. Patents are hereby incorporated by reference.

PTFE, polytetrafluoroethylene (for example Teflon® 6C; E. I. Du Pont), may be advantageously added to the present compositions as an additional flame retardant, as disclosed in U.S. application 60/312,517, filed Aug.15, 2001.

Advantageously, present composition contains only minor amounts of antimony compounds such as Sb₂O₃, e.g. less than about 1%, for instance less than about 0.1% by weight of the coating component (A); for example, the present compositions are essentially free of antimony.

Flame-retardant fillers are not required in order to improve the flame retardant properties and achieve a higher rating, e.g. in the UL-94 burning test (infra). Consequently, the compositions of the present invention may contain only minor amounts of flame-retardant fillers, e.g. less than about 3%, for instance less than about 1%, for example less than about 0.1% by weight of the coating component (A); for example, the present compositions are essentially free of flame-retardant fillers.

Flame-retardant fillers are known in the art and are selected from the group consisting of magnesium hydroxide, alumina trihydrate and zinc borate. Coatings may contain flame-retardant fillers such as vermiculite or Portland cement. Flame-retardant fillers are inorganic compounds employed for flame-retardant properties, and at high enough levels to be considered “filler”.

If conventional fillers such as talc, calcium carbonate and the like are normally employed for instance for flow properties in order to reduce the spread of flaming droplets (not flame-retardant per se), such conventional fillers may also be reduced with the use of the present compositions. For instance, the present compositions may contain only minor amounts of conventional fillers, for example less than about 3%, for instance less than 1%, for example less than about 0.1% by weight of the coating component (A); for example, the present compositions are essentially free of conventional fillers.

Further, the present invention allows for conventional fillers to take the place of more expensive flame-retardant fillers.

The resulting stabilized compositions of the invention may optionally also contain various conventional additives, for example in amounts from about 0.01 to about 10%, for instance from about 0.025 to about 4%, for example from about 0.1 to about 2% by weight of component (A), such as the materials listed below, or mixtures thereof.

1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-meth-oxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctyl-thiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octade-cyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis-(3,5-di-tert-butyl-4-hydroxyphenyl)adipate.

1.4. Tocopherols, for example α-tocopherol, β-tocopherol, γ-tocopherol, δ-tocopherol and mixtures thereof (Vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis-(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyll-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis-(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis-(3,5-di-tert-butyl-2-hydroxybenzyl)-malonate, di-octadecyl-2-(3-tert-butyl-4-hydroxy-5-methylbenzyl)-malonate, di-dodecylmercaptoethyl-2,2-bis-(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris-(3,5-di-tert-butyl-4-hydroxy-benzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine Compounds, for example 2,4-bis(octylmercapto)-6-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris-(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicyclohexyl-4-hydroxybenzyl)iso-cyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylol-propane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethyl-olpropane, 4-hydroxymethyl-1-phospha-2,6,7-trioxabicyclo[2.2.2]octane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, tri-ethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3.5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)-hydrazide, N,N′-bis[2-(3-[3,5-di-tert-butyl-4-hydroxyphenyl]propionyloxy)ethyl]oxamide (Naugard® XL-1 supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenlenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octa-decanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyidiphenylamines, a mixture of mono- and dialkylated dodecyldiphenylamines, a mixture of mono- and dialkylated isopropyl/isohexyldiphenylamines, a mixture of mono- und dialkylated tert-butyldiphenylamines, 2,3-dihydro-3,3-dimethyl-4H-1,4-benzothiazine, phenothiazine, a mixture of mono- und dialkylated tert-butyl/tert-octylphenothiazines, a mixture of mono- und dialkylated tert-octyl-phenothiazines, N-allylphenothiazin, N,N,N′,N′-tetraphenyl-1,4-diaminobut-2-ene, N,N-bis(2,2,6,6-tetramethyl-piperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

2. UV Absorbers and Light Stabilizers

2.1. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂ [symbol] ₂ where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]-benzotriazole; 2-[2′-hydroxy-3′-(1,1,3,3-tetramethylbutyl)-5′-(α,α-dimethylbenzyl)-phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, as for example 4-tertbutyl-phenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxy-cinnamate, butyl α-cyano-β-methyl-p-methoxy-cinnamate, methyl α-carbomethoxy-p-methoxycinnamate and N-(β-carbomethoxy-β-cyanovinyl)-2-methylindoline.

2.5. Nickel compounds, for example nickel complexes of 2,2′-thio-bis-[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenyl undecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)-malonate, 3-n-octyl-7,7,9,9-tetramethyl-1,3,8-triazaspiro[4.5]decan-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis-(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza4-oxo-spiro[4,5]decane, a reaction product of 7,7,9,9-tetramethyl-2-cycloundecyl-1-oxa-3,8-diaza-4-oxospiro[4,5]decane und epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, diester of 4-methoxy-methylene-malonic acid with 1,2,2,6,6-pentamethyl-4-hydroxypiperidine, poly[methylpropyl-3-oxy-4-(2,2,6,6-tetramethyl-4-piperidyl)]siloxane, reaction product of maleic acid anhydride-α-olefin-copolymer with 2,2,6,6-tetramethyl-4-aminopiperidine or 1,2,2,6,6-pentamethyl-4-aminopiperidine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxy-propoxy)phenyl]-4,6-bis(2,4-dimethyl)-1,3,5-triazine, 2-[2-hydroxy-4-(2-hydroxy-3-octyloxy-propyloxy)phenyl]-4,6-bis(2,4-dimethyl)-1,3,5-triazine, 2-[4-(dodecyloxy/tridecyloxy-2-hydroxypropoxy)-2-hydroxy-phenyl]-4,6-bis(2,4-dimethylphenyl)-1,3,5-triazine, 2-[2-hydroxy-4-(2-hydroxy-3-dodecyloxy-propoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxy-propoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosphites and phosphonites, for example triphenyl phosphite, diphenyl alkyl phosphites, phenyl dialkyl phosphites, tris(nonylphenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl)pentaerythritol diphosphite, bis(2,6-di-tert-butyl-4-methylphenyl)-pentaerythritol diphosphite, diisodecyloxypentaerythritol diphosphite, bis(2,4-di-tert-butyl-6-methylphenyl)pentaerythritol diphosphite, bis(2,4,6-tris(tert-butyl-phenyl)pentaerythritol diphosphite, tristearyl sorbitol triphosphite, tetrakis(2,4-di-tert-butylphenyl)4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane.

Specific examples are the following phosphites:

Tris(2,4-di-tert-butylphenyl)phosphite (Irgafos® 168, Ciba-Geigy), tris(nonylphenyl)phosphite,

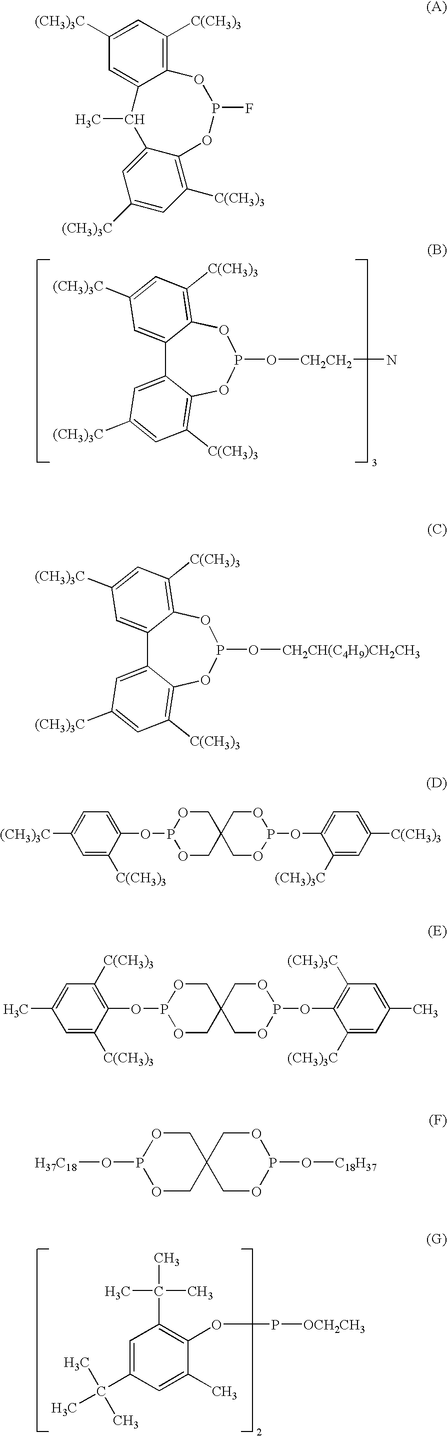

5. Hydroxylamines, for example, N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Nitrones, for example, N-benzyl-alpha-phenyl-nitrone, N-ethyl-alpha-methyl-nitrone, N-octyl-alpha-heptyl-nitrone, N-lauryl-alpha-undecyl-nitrone, N-tetradecyl-alpha-tridcyl-nitrone, N-hexadecyl-alpha-pentadecyl-nitrone, N-octadecyl-alpha-heptadecyl-nitrone, N-hexadecyl-alpha-heptadecyl-nitrone, N-ocatadecyl-alpha-pentadecyl-nitrone, N-heptadecyl-alpha-heptadecyl-nitrone, N-octadecyl-alpha-hexadecyl-nitrone, nitrone derived from N,N-dialkylhydroxylamine derived from hydrogenated tallow amine.

7. Thiosynergists, for example, dilauryl thiodipropionate or distearyl thiodipropionate.

8. Peroxide scavengers, for example esters of P-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

9. Polyamide stabilisers, for example, copper salts in combination with iodides and/or phosphorus compounds and salts of divalent manganese.

10. Basic co-stabilisers, for example, melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids for example calcium stearate, zinc stearate, magnesium behenate, magnesium stearate, sodium ricinoleate and potassium palmitate, antimony pyrocatecholate or zink pyrocatecholate.

11. Nucleating agents, for example, inorganic substances such as talcum, metal oxides such as titanium dioxide or magnesium oxide, phosphates, carbonates or sulfates of, for example, alkaline earth metals; organic compounds such as mono- or polycarboxylic acids and the salts thereof, e.g. 4-tert-butylbenzoic acid, adipic acid, diphenylacetic acid, sodium succinate or sodium benzoate; polymeric compounds such as ionic copolymers (ionomers). Specific examples are 1,3:2,4-bis(3′,4′-dimethylbenzylidene)sorbitol, 1,3:2,4-di(paramethyldibenzylidene)sorbitol, und 1,3:2,4-di(benzylidene)sorbitol.

12. Fillers and reinforcing agents, for example, calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.

13. Other additives, for example, plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839 or EP-A-0591102 or 3-[4-(2-acetoxyethoxy)-phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, 3-(2,3-dimethylphenyl)-5,7-di-tert-butyl-benzofuran-2-one.

15. Amine oxides, for example amine oxide derivatives as disclosed in U.S. Pat. Nos. 5,844,029 and 5,880,191, didecyl methyl amine oxide, tridecyl amine oxide, tridodecyl amine oxide and trihexadecyl amine oxide. U.S. Pat. Nos. 5,844,029 and 5,880,191 disclose the use of saturated hydrocarbon amine oxides towards the stabilization of thermoplastic resins. It is disclosed that the thermoplastic compositions may further contain a stabilizer or mixture of stabilizers selected from phenolic antioxidants, hindered amine light stabilizers, ultraviolet light absorbers, organic phosphorus compounds, alkaline metal salts of fatty acids and thiosynergists.

Specific examples of additives are phenolic antioxidants (item 1 of the list), further sterically hindered amines (item 2.6 of the list), light stabilizers of the benzotriazole and/or o-hydroxyphenyltriazine class (items 2.1 and 2.8 of the list), phosphites and phosphonites (item 4 of the list) and peroxide-destroying compounds (item 5.) of the list.

Additional specific examples of additives (stabilizers) which are benzofuran-2-ones, such as described, for example, in U.S. Pat. No. 4,325,863, U.S. Pat. No. 4,338,244 or U.S. Pat. No. 5,175,312.

The instant compositions can additionally contain another UV absorber selected from the group consisting of the s-triazines, the oxanilides, the hydroxybenzophenones, benzoates and the α-cyanoacrylates. Particularly, the instant composition may additionally contain an effective stabilizing amount of at least one other 2-hydroxyphenyl-2H-benzotriazole; another tris-aryl-s-triazine; or hindered amine or mixtures thereof. For example, additional components are selected from pigments, dyes, plasticizers, antioxidants, thixotropic agents, levelling assistants, basic costabilizers, further light stabilizers like UV absorbers and/or sterically hindered amines, metal passivators, metal oxides, organophosphorus compounds, hydroxylamines, and mixtures thereof, especially pigments, phenolic antioxidants, calcium stearate, zinc stearate, UV absorbers of the 2-(2′-hydroxyphenyl)benzotriazole and 2-(2-Hydroxyphenyl)-1,3,5-triazine classes, and sterically hindered amines.

The present compositions may also comprise a spumific agent. Examples are a combination of tris(2-hydroxylethyl)isocyanurate and ammonium polyphosphate, melamine, methylolated melamine, hexamethoxymethyl melamine, melamine monophosphate, melamine biphosphate, melamine polyphosphate, melamine pyrophosphate, urea, dimethylurea, dicyandiamide, guanylurea phosphate, glycine or amine phosphate. The foregoing release nitrogen gase when the decompose upon exposure to heat. Compounds which release carbon dixoxide or water vapor upon exposure to heat can also be employed.

The present compositions may comprise a carbonific material (a poly-hydro compound) such as pentaerthritol, dipentaerythritol, tripentaerthritol, pentaerythritol polyurethanes, phenol triethylene glycol, resorcinol, inositol, sorbitol, dextrin and starch.

The present compositions may comprise silica.

The additives of the invention and optional further components may be added to the coating formulation individually or mixed with one another. If desired, the individual components can be mixed with one another before incorporation into the coating for example by dry blending, compaction or in the melt.

Component (i) is advantageously contained in the composition of the invention in an amount from about 0.1% to about 10% by weight based on the coating component (A); for example from about 0.25% to about 8% by weight; for instance from about 0.5% to about 3% by weight. For instance, component (i) is present from about 0.25% to about 10% or from about 0.5% to about 10% by weight based on (A). For example, component (i) is present from about 0.1% to about 8% or from about 0.1% to about 3% by weight based on (A).

Component (ii) is advantageously contained in the composition of the invention in an amount from about 0.5% to about 45% by weight of the coating (A); for instance about 3% to about 40%; for example about 5% to about 35% by weight of component (A). For example, component (ii) is employed from about 0.5% to about 10% by weight, from about 1% to about 10%, from about 3% to about 10% or from about 5% to about 10% by weight, based on the weight of the polymeric substrate. For example, component (ii) is employed from about 0.5% to about 8%, from about 0.5% to about 6%, from about 0.5% to about 5%, or from about 0.5% to about 3% by weight, based on the weight of the polymeric substrate.

The ratio (parts by weight) of component (i) to component (ii) is for example between about 1:5 to about 1:200, for instance from about 1:50 to about 1:100, or about 1:10 to about 1:25. For example the ratio of component (i) to component (ii) is from about 1:10 to about 1:200, from about 1:25 to about 1:200, from about 1:50 to about 1:200 or from about 1:100 to about 1:200. For example, the weight ratio of component (i) to component (ii) is from about 1:5 to about 1:100, from about 1:5 to about 1:50, from about 1:5 to about 1:25, or from about 1:5 to about 1:10.

The amount of the conventional flame retardants employed also depends on the effectiveness of the specific compound(s), the specific coating and application type; for example, an amount of 5 to 15% by weight of the compound tris[3-bromo-2,2-bis(bromomethyl)propyl]phosphate may be as efficient as an amount of 30 to 45% by weight of the compound decabromodiphenyl oxide in respect of the flame retardancy of the final composition. Isocyanurate flame retardants are normally employed between about 1 and about 10% by weight based on (A), for example between about 3 and about 6% by weight.

The coatings of the present invention are themselves flame retardant, and likewise provide flame retardancy to the substrates and articles on which they are coated. Accordingly, a further subject of the present invention is a flame retardant coated article comprising a substrate coated with a flame retardant coating composition comprising

(A) a coating and

(B) an effective flame retarding amount of a mixture of
(i) at least one compound selected from the group consisting of the
   (a) sterically hindered nitroxyl stabilizers,
   (b) sterically hindered hydroxylamine stabilizers and
   (c) sterically hindered alkoxyamine stabilizers and
(ii) at least one conventional flame retardant selected from the group consisting of
   (d) organohalogen flame retardants,
   (e) organophosphorus flame retardants
   (f) isocyanurate flame retardants and
   (g) melamine based flame retardants.

The effective flame retarding amount of component (B) is that needed to show flame retarding efficacy as measured by one of the standard methods used to assess flame retardancy. These include the NFPA 701 Standard Methods of Fire Tests for Flame-Resistant Textiles and Films, 1989 and 1996 editions; the UL 94 Test for Flammability of Plastic Materials for Parts in Devices and Appliances, 5th Edition, Oct. 29, 1996; Limiting Oxygen Index (LOI), ASTM D-2863; and Cone Calorimetry, ASTM E-1354. Ratings according to the UL 94 V test are as compiled in the following table:

| | Afterflame | Burning | Burn to |
|---|---|---|---|
| Rating | time | drips | Clamp |
| V-0 | <10 s | no | no |
| V-1 | <30 s | no | no |
| V-2 | <30 s | yes | no |
| Fail | <30 s | | yes |
| Fail | >30 s | | no |

Applicable Tests Include:

ASTM F1173 Fiberglass pipe and fittings (offshore/marine)

UL 94 and 746C Tests for Flammability of Plastic Materials for Parts in Devices and Applications

UL 723

IEEE-45—recommended practice for electrical installation on shipboard

IEEE-383—standard for type test of class IE electrical cables, field splices and connections for nuclear power generation stations.

ASTM-D-1360—fire retardancy of paints (cabinet method)

ASTM-E-84—test for surface burning characteristics of building materials

ASTM-E-119—fire test of building construction materials

ASTM-E-162—surface flammability of materials using a radiant heat energy source

ASTM F 84

FAA 14-25.853, 0.855, 0.856, 0.867—aeronautics and space (fire protection)

Paper substrates (saturants) (Michelman): ASTM E-162, ASTM E-662, NFPA 701, TAPPI 461

Corrugated materials w/FR coatings (Michelman): ASTM E-162/662, FMR heat release, NFPA 30, ASTM E-84, NFPA 703, UL723

NFPA 703: Standard for Fire Retardant Impregnated Wood and Fire Retardant Coatings for Building Materials

NFPA 255, Fire Endurance Tests of Building Construction Materials

Military specifications DOD-En 24607A and DOD-R-21417A (SH)

Coadditives found particularly useful for use with the instant compounds in flame retardant compositions are as follows:

UV Absorbers:

2-(2-hydroxy-3,5-di-α-cumylphenyl)-2H-benzotriazole, (TINUVIN® 234, Ciba Specialty Chemicals Corp.);

2-(2-hydroxy-5-methylphenyl)-2H-benzotriazole, (TINUVIN® P, Ciba Specialty Chemicals Corp.);

5-chloro-2-(2-hydroxy-3,5-di-tert-butylphenyl)-2H-benzotriazole, (TINUVIN® 327, Ciba Specialty Chemicals Corp.);

2-(2-hydroxy-3,5-di-tert-amylphenyl)-2H-benzotriazole, (TINUVIN® 328, Ciba Specialty Chemicals Corp.);

2-(2-hydroxy-3-α-cumyl-5-tert-octylphenyl)-2H-benzotriazole, (TINUVIN® 928, Ciba Specialty Chemicals Corp.);

2,4-di-tert-butylphenyl 3,5-di-tert-butyl-4-hydroxybenzoate, (TINUVIN® 120, Ciba Specialty Chemicals Corp.);

2-hydroxy-4-n-octyloxybenzophenone, (CHIMASSORB® 81, Ciba Specialty Chemicals Corp.);

2,4-bis(2,4-dimethyphenyl)-6-(2-hydroxy-4-octyloxyphenyl)-s-triazine, (CYASORB® 1164, Cytec).

The following examples are meant for illustrative purposes only and are not to be construed to limit the scope of this invention in any manner whatsoever. Where given, room temperature depicts a temperature in the range 20-25° C. Percentages are by weight of the coating substrate unless otherwise indicated.

Test Methods

NFPA 701 Standard Methods of Fire Tests for Flame-Resistant Textiles and Films, 1989 and 1996 editions;

UL 94 Test for Flammability of Plastic Materials for Parts in Devices and Appliances, 5th Edition, Oct. 29, 1996;

Limiting Oxygen Index (LOI), ASTM D-2863;

Cone Calorimetry, ASTM E-1 or ASTM E 1354;

ASTM D 2633-82, burn test.

### EXAMPLE 1

### Coatings Over TPO

Molded test specimens are prepared by injection molding thermoplastic olefin (TPO) pellets containing pigments, a phosphite, a phenolic antioxidant or hydroxylamine, a metal stearate, ultraviolet light absorbers or a hindered amine stabilizer or a mixture of UV absorber and hindered amine stabilizer.

Pigmented TPO pellets are prepared from pure pigment or pigment concentrate, coadditives and commercially available TPO by mixing the components in a Superior/MPM 1″ single screw extruder with a general all-purpose screw (24:1 L/D) at 400° F. (200° C.), cooled in a water bath and pelletized. The resulting pellets are molded into 60 mil (0.006 inch), 2″×2″ plaques at about 375° F. (190° C.) on a BOY 30M Injection Molding Machine.

Pigmented TPO formulations composed of polypropylene blended with a rubber modifier where the rubber modifier is an in-situ reacted copolymer or blended product containing copolymers of propylene and ethylene with or without a ternary component such as ethylidene norbornene are stabilized with a base stabilization system consisting of an N,N-dialkylhydroxyl-amine or a hindered phenolic antioxidant with or without an organophosphorus compound.

All additive and pigment concentrations in the final formulation are expressed as weight percent based on the resin.

Formulations contain thermoplastic olefin pellets and one or more of the following components:

0.0 to 2.0% pigment,

0.0 to 50.0% talc,

0.0 to 0.1% phosphite,

0.0 to 1.25% phenolic antioxidant,

0.0 to 0.1% hydroxylamine

0.05 to 0.10 calcium stearate,

0.0 to 1.25% UV absorber and

0.0 to 1.25% hindered amine stabilizer.

The components are dry-blended in a tumble dryer prior to extrusion and molding.

Polymer substrate is commercially available polyolefin blend POLYTROPE® TPP 518-01 supplied by A. Schulman Inc. Akron, Ohio)

The light stable formulations are painted with one-pack paint systems and tested for TPO/paint interactions and flame retardancy. Before painting, the test specimens are first washed in accordance with GM998-4801 and dried for 15 minutes at 200° F. (94° C.). Adhesion promoter is applied to the dry film thickness of 0.2-0.4 mils. The samples are dried for five minutes before a 1K basecoat is applied to a film thickness of 1.2-1.4 mils. The painted panels are dried for three minutes, a clearcoat is then applied to a dry film thickness of 1.2-1.5 mils followed by ten minutes flash drying and a 30 minute oven bake at 250° F. (121° C.).

One or more of the coating formulations comprise an additive selected from present compounds (a)-(o) and a conventional organohalogen, organophosphorus, isocyanurate or melamine based flame retardant.

Paint adhesion is measured by Aggressive Adhesion Testing (proprietary test procedure conducted at Technical Finishing, Inc.) and Taber Scuff. Painted panels which retain greater than 80% of the paint finish are considered acceptable. After Aggressive Adhesion Testing, samples with less than 5% paint loss are deemed acceptable.

The present painted articles with coatings comprising additives (a)-(o) and a conventional flame retardant exhibit excellent paint adhesion and flame retardancy. The additives (a)-(o) combined with convention flame retardants may be in any or all coating layers.

### EXAMPLE 2

### Urethane Clearcoat Over Steel

The present stabilizers (a)-(o) are incorporated into a two-component polyester urethane coating based on a commercially available polyester polyol (DESMOPHEN® 670-80) and commercially available isocyanurate (DESMODUR® N-3390) at a level of 2% by weight based on total resin solids. The coating system is catalyzed with 0.015% dibutyl tin dilaurate based on total resin solids. The coating system also contains a conventional organohalogen, organophosphorus, isocyanurate or melamine based flame retardant.

The system is catalyzed with 0.02% by weight of dibutyltin dilaurate based on the total resin solids. The stabilizers and conventional flame retardants are added at the appropriate level to the acrylic polyol portion of the two-component coating which is then combined with the isocyanate component immediately prior to application.

Steel panels 3″×4″ primed with an electrocoat primer are then coated with a light blue metallic basecoat, then with the stabilized, flame retardant clearcoat. The basecoat is spray applied to a thickness of 1.0 mil (25 microns) dry film thickness and the stabilized clearcoat is then applied to a thickness of 2.0 mils (50 microns) dry film thickness. The coating is air-dried and aged for two weeks. The coatings exhibit excellent flame retardancy.

### EXAMPLE 3

### Waterborne Wood Varnish

Waterborne coatings comprise a significant and increasing proportion of the coating in use for a wide variety of applications including automotive basecoats, industrial coatings and trade sale coatings. These coatings may be pigmented or transparent.

The test stabilizers (a)-(o) and a conventional organohalogen, organophosphorus, isocyanurate or melamine based flame retardant are incorporated into a waterborne dispersion by predissolution in a cosolvent blend. The waterborne dispersion is a commercially available acrylic/urethane hybrid resin. The cosolvent blend is a 1:1 mixture of TEXANOL® (2,2,4-trimethyl-1,3-pentanediol, Texaco) and ARCOSOLVE® TPM (tripropylene glycol methyl ether, AtlanticRichfield).

The test stabilizer (a)-(o), 0.45 grams, and an appropriate amount of conventional flame retardant is predissolved in 10 g of the cosolvent blend which is then incorporated into the following composition:

| | ppw |
|---|---|
| FLEXTHANE ® 630 (Air Products) | 100.0 |
| Foamaster VF | 0.1 |
| Water | 10.0 |
| TEXANOL/ARCOSOLVE/hindered amine | 10.5 |
| UV absorber (TINUVIN ® 1130, Ciba) | 1.2 |
| BYK 346 | 0.5 |
| MICHEMLUBE ® 162 | 2.0 |

Each coating is brush applied onto 6″×6″ sections of cedar and pine boards. The weight of the coating applied is regulated by weighing the coating and brush before and after application and ensuring that the same weight of coating is applied to each section.

The coated board sections are allowed to dry at ambient temperature for two weeks, then evaluated for flame retardancy. The boards exhibit excellent flame retardancy.

### EXAMPLE 4

### Coil Coating

A white polyester/melamine based oil-free alkyl coil coating is utilized in this example. The fully formulated paint, comprising a present additive (a)-(o) and a conventional organohalogen, organophosphorus, isocyanurate or melamine based flame retardant, is applied over a primed steel sheet using a wire wound rod to give 0.6-0.8 mil dry film. The panels are baked for about 90 seconds at 220° C., removed from the oven and immediately quenched in water. The coated panels exhibit excellent flame retardancy.

### EXAMPLE 5

### Tung Oil Phenolic Varnish

Pieces of 1.27 cm×20.32 cm×30.48 cm western red cedar panels having a fine radial cut are used to test a commercially available tung oil phenolic varnish (supplied by McCloskey). Each panel is coated with two coats of varnish formulated with an appropriate amount of an additive selected from (a)-(o) and a conventional organohalogen, organophosphorus isocyanurate or melamine based flame retardant. After storage for two weeks at ambient temperature, the wood panels are tested for flame retardancy. The panels exhibit excellent flame retardancy.

### EXAMPLE 6

### Aromatic Urethane Varnish

A sample of commercial aromatic urethane varnish (Flecto-Varathane #90) is formulated with a present additive of (a)-(o) and a convention organohalogen or organophosphorus flame retardant. The varnish is coated (two coats) on red cedar panels. The panels exhibit excellent flame retardancy.

### EXAMPLE 7

### Abrasion-Resistant Coating Compositions

A solution in isopropanol of 50% (by weight) of 1,6-hexanediol, 10% 3-methacryloyloxy-propyltrimethoxysilane and 40% colloidal silica (in form of a 34% aqueous dispersion) is vacuum stripped to remove volatiles and combined with an instant compound of (a)-(o), a conventional organohalogen, organophosphorus, isocyanurate or melamine based flame retardant, a benzotriazole UV absorber and 2,4,6-trimethylbenzoyldiphenylphosphine photoinitiator. These compositions show no gelation on storage.

The compositions above are applied by roller coating to a 15 mil film of bisphenol A polycarbonate and the coated films are passed under a mercury lamp at 43° C. at a line speed of 610 cm/min. The compositions are cured to a colorless and optically clear coatings over the polycarbonate substrate.

The coatings as measured by the Taber Abrasion Test (ASTM D1044) are abrasion resistant.

The test specimens exhibit excellent flame retardancy.

### EXAMPLE 8

### Coating Over Polycarbonate

A two-component polyester urethane coating is formulated with an instant hindered amine compound of (a)-(o) and a conventional organohalogen, organophosphorus, isocyanurate or melamine based flame retardant. The high-solids polyester polyol (Desmophen 670-80, Bayer) is crosslinked with an isocyanate based resin (Desmodue N-3390, Bayer). The coating is catalyzed with 0.015% by weight of dibutyltin dilaurate catalyst.

Plaques of polycarbonate-based plastic substrate (Xenoy) 4″×6″ are coated with the formulated clear coat at a thickness of approximately 1.5 mils. The coating is spray applied to the substrate and then baked at 82° C. for 20 minutes.

After storage for one week at room temperature, each plaque is cut into 2″×3″ strips with five replicates being made for each formulation. The plaques exhibit excellent flame retardancy.

### EXAMPLE 9

### Glycidyl Methacrylate-Based Powder Clearcoat

One of the major new coating technologies which can be used to meet increasingly stringent VOC solvent emission requirements is the use of powder coatings. Applications requiring the use of light stabilizers include clearcoats for finishing of automotive topcoats, finishing of garden implements, protection of automotive wheel covers. For optimum incorporation and shelf stability, stabilizers used in a powder coating should be moderate-melting (˜100° C.) solids, nonvolatile, and heat stable at typical powder coating baking temperatures (140-180° C.).

Prior to incorporation of the stabilizers (a)-(o) and the conventional flame retardants under test, a premix of commercially available GMA-based powder coating resin, UV absorber, and flow aids is made by extruding together at 145° C. The stabilizers (a)-(o) and a conventional organohalogen, organophosphourus, isocyanurate or melamine based flame retardant under test are then incorporated into portions of this premix, along with a commercially available 1,12 dodecanoic acid crosslinking resin. The final mix is extruded at 100° C., then the extrudate is milled on an ultracentrifugal mill and powder cyclone, and sieved. The powders are electrostatically sprayed onto a basecoat to a film thickness of 60 microns. The coatings are cured for 30 minutes at 160° C.

The panels exhibit excellent flame retardancy.

### EXAMPLE 10

### Oil Modified Urethane Alkyd for Wood Application

The stabilizers (a)-(o) and a conventional organohalogen, organophosphorus, isocyanurate or melamine based flame retardant under test are incorporated into a commercially available solvent-borne urethane alkyd McWhorter 43-4355. A 2-hydroxy benzotriazole UV absorber is also incorporated into all formulations. After mixing, the clear coatings are applied by brushing to white pine boards. Three coats are applied and the wood samples are allowed to dry for 1 week.

The panels exhibit excellent flame retardancy.

### EXAMPLE 11

### Preformed Films for Lamination to Plastic Parts

The instant invention also pertains to protective and decorative films which are preformed, then applied to a substrate via a dry paint transfer process. These films consist of a single decorative layer which is applied to a carrier sheet, then laminated to a self-supporting, thermoformable backing sheet. The carrier sheet is then removed from the opposite side of the film, exposing the decorative layer. The composite film/backing sheet then is thermoformed to a three-dimensional shape. Additionally, these films may also consist of multiple layers, where, for example, a thermoplastic, thermoformable clearcoat is applied to the carrier sheet, then hardened to form an optically clear film. A color coat is then applied to the exposed face of the clearcoat, and hardened, resulting in a clear coat/color coat paint film supported by the carrier. This composite is then laminated to a thermoformable backing sheet, as above. The carrier sheet is removed, as above, and the composite clearcoat/colorcoat/backing is then thermoformed, as above. Laminated articles with films comprising an additive selected from (a)-(o) and a conventional organohalogen, organophosphorus, isocyanurate or melamine based flame retardant exhibit excellent flame retardancy. The additives are advantageously used in one or all layers of film.

The polymeric resins for the above application must be thermoplastic, and may be fluoropolymer/acrylic blends.

### EXAMPLE 12

### Coextrusion Over PVC

A sheet composition suitable for use in weatherable house siding is prepared by coextrusion of a 0.010″ thick light stabilized rigid PVC layer (“cap layer”) over a 0.060″ thick rigid PVC bulk substrate (“bulk layer”). Composition of the layers is given below.

| | |
|---|---|
| Cap | 100.00 phr PVC |
| Layer | 2.50 phr IRGASTAB ® T 634 (thermal stabilizer) |
| | 6.00 phr KM-334 (acrylic impact modifier - Rohm & Haas) |
| | 1.50 phr K-120N (processing aid - Rohm & Haas) |
| | 0.60 phr Paraffin Wax 165 (Rheolube) |
| | 0.30 phr PE Wax AC629A (Honeywell) |
| | 0.50 phr Gray color concentrate |
| | 4.70 phr R-960 titanium dioxide (DuPont) |
| | 0.50 phr TINUVIN ® 328 (UV absorber) |
| Bulk | 100.00 phr PVC |
| Layer | 2.50 phr IRGASTAB ® T 634 (thermal stabilizer) |
| | 6.00 phr KM-334 (acrylic impact modifier - Rohm & Haas) |
| | 1.50 phr K-120N (processing aid - Rohm & Haas) |
| | 0.60 phr Paraffin Wax 165 (Rheolube) |
| | 0.30 phr PE Wax AC629A (Honeywell) |

The cap layer additionally contains a present additive selected from (a)-(o) and a conventional organohalogen, organophosphorus, isocyanurate or melamine based flame retardant.

The PVC cap layer may be replaced with ASA, PMMA, polyvinylidene fluoride (PVDF) or polypropylene-PMMA graft copolymer (PP-g-PMMA) cap layers as per the following formulations. In each case the bulk layer is as above.

| | |
|---|---|
| Cap | 100.00 phr ASA (e.g. GELOY ® from GE Plastics) |
| Layer | 0.50 phr Gray color concentrate |
| | 4.70 phr R-960 titanium dioxide (DuPont) |
| | 0.50 phr TINUVIN ® 328 (UV absorber) |
| | 0.10 phr IRGANOX ® B 900 (process stabilizer) |
| Cap | 100.00 phr impact-modified PMMA |
| Layer | 0.50 phr Gray color concentrate |
| | 4.70 phr R-960 titanium dioxide (DuPont) |
| | 0.50 phr TINUVIN ® 234 (UV absorber) |
| | 0.10 phr IRGANOX ® B 900 (process stabilizer) |
| Cap | 100.00 phr PVDF (e.g. KYNAR ® from Elf Atochem) |
| Layer | 0.50 phr Gray color concentrate |
| | 4.70 phr R-960 titanium dioxide (DuPont) |
| | 0.50 phr TINUVIN ® 213 (UV absorber) |
| Cap | 100.00 phr PP-g-PMMA (e.g. INTERLOY ® from Montell) |
| Layer | 0.50 phr Gray color concentrate |
| | 4.70 phr R-960 titanium dioxide (DuPont) |
| | 0.20 phr CHIMASSORB ® 2020 (HALS) |
| | 0.20 phr TINUVIN ® 328 (UV absorber) |
| | 0.10 phr IRGASTAB ® FS 301 (process stabilizer) |

In each case, the cap layer additionally contains a present additive selected from (a)-(o) and a conventional organohalogen, organophosphorus, isocyanurate or melamine based flame retardant.

In each case, the multilayer systems exhibit excellent flame retardance.

### EXAMPLE 13

### Coextrusion Over Polycarbonate

A sheet composition suitable for use in weatherable glazing is prepared by coextrusion of a 0.010″ thick light stabilized PMMA layer (“cap layer”) over a 0.100″ thick polycarbonate bulk substrate (“bulk layer”). Composition of the layers is given in the table below.

| | |
|---|---|
| Cap Layer | 100.00 phr PMMA |
| | 0.10 phr IRGANOX ® B 900 (process stabilizer) |
| | 3.50 phr TINUVIN ® 1577 (UV absorber) |
| Bulk Layer | 100.00 phr Polycarbonate (e.g. LEXAN ® 141 from GE) |
| | 0.08 phr IRGAFOS ® 168 (process stabilizer) |
| | 0.10 phr TINUVIN ® 234 (UV absorber) |

The cap layer additionally contains a present additive selected from (a)-(o) and a conventional organohalogen, organophosphorus, isocyanurate or melamine based flame retardant.

Coextruded sheets are also prepared, replacing Tinuvin® 1577 in the cap layer with each of Tinuvin® 360 and Tinuvin® 234.

Tinuvin® 234 (Ciba) is 2-(2-hydroxy-3,5-di-α-cumylphenyl)-2H-benzotriazole, Tinuvin® 1577 (Ciba) is 4,6-diphenyl-2-(4-hexyloxy-2-hydroxyphenyl)-s-triazine and Tinuvin® 360 is 2,2′-methylene-bis(4-t-octyl-(6-2H-benzotriazol-2-yl)phenol).

The multilayer systems exhibit excellent flame retardancy.

### EXAMPLE 14

### Coextrusion Over ABS

A composition suitable for use as weatherable window profile is prepared by coextrusion of a 0.010″ thick light stabilized ASA layer (“cap layer”) over a 0.060″ thick ABS bulk substrate (“bulk layer”). Composition of the layers is given in the table below.

| | |
|---|---|
| Cap Layer | 100.00 phr ASA (e.g. GELOY ® from GE Plastics) |
| | 4.00 phr R-960 titanium dioxide (DuPont) |
| | 0.50 phr TINUVIN ® 328 (UV absorber) |
| | 0.10 phr IRGANOX ® B 900 (process stabilizer) |
| Bulk Layer | 100.00 phr ABS (e.g. CYCOLAC ® from GE Plastics) |
| | 0.10 phr IRGANOX ® B 900 (process stabilizer) |

The cap layer additionally contains a present additive selected from (a)-(o) and a conventional organohalogen, organophosphorus, isocyanurate or melamine based flame retardant.

The multilayer systems exhibit excellent flame retardancy.

### EXAMPLE 15

### Multilayer Polymer Structures

The present additive combinations of components (i) and (ii), for example an additive selected from (a)-(o) and a conventional organohalogen, organophosphorus, isocyanurate or melamine based flame retardant, when present in one or more than one layers of a multilayer structure, provide effective flame retardancy to said structures. Examples of such polymer structures include but are not limited to:

1.) Sheets and signs as seen in U.S. Pat. No. 6,291,586; and U.S. Pat. No. 5,387,458 which are incorporated herein by reference;

2.) Solar Control Films of Various Construction as seen in U.S. Pat. Nos. 3,290,203, 3,681,179, 3,776,805 and 4,095,013, incorporated herein by reference; and

3.) Base stock or cap stock for coextrusion structures such as window profiles, laminates over automotive bumpers or auto exterior panels.

Window profiles include photosensitive polymers such as ABS, ASA, SAN or vinylogous polymers such as PVC. Automotive polymeric materials which are photosensitive include for example ABS, SAN, ASA and polycarbonate as well as blends such as PC/ABS, which include Pulse® from Dow, Cycoloy® from GE, Bayblend® from Bayer, PC/PBT known as Xenoy® from GE, PC/ASA such as Geloy® from GE, and the “W-4” polymer as disclosed by General Electric Company (Modern Plastics May 2000 pages 90-91).

A multilayer polymer composite is prepared by different routes, such as co-extrusion of one or more polymer compositions to form the multilayer composite. Alternatively, compression molding or thermoforming of one or polymer compositions produces the desired polymer composite. In particular, these techniques are used in the manufacture of signage, typically composed of one or more layers of polymeric materials formed on top of a base material (metal sheet, plastic, etc).

Examples of potential polymeric materials which may comprise one or more sections of the laminate, sign, sheet or composite structure may include:

polycarbonate

polyesters such as PET, PBT, PEN, PTT

acrylics such as PMMA and acrylate copolymer or terpolymers

polyolefins

vinylogous polymers and copolymers composed of vinyl chloride, vinyl acetate, vinylidene chloride, vinylidene fluoride.

The present additives selected from (a)-(o) in combination with a conventional organohalogen, organophosphorus, isocyanurate or melamine based flame retardant each provide excellent flame retardancy to such constructions.

### EXAMPLE 16

### Photo-Cured White Pigmented Coating

A model white UV-curable coating for wood is prepared based on polyester acrylate chemistry with a titanium dioxide level of 25% by weight. A base formulation is prepared consisting of:

Rutile TiO₂, 100.0 g

Ebercryl® 830, 240.0 g

HDODA, 42 g

TMPTA, 18.0g

The TiO₂ is added as a 63% dispersion in a portion of the Ebercryl® 830. Ebercryl® 830 is a hexafunctional polyester acrylate oligomer. HDODA is 1,6-hexanediol diacrylate. TMPTA is trimethylolpropane triacrylate. The Ebecryl® products as well as the acrylate monomers are available from UCB Chemicals Corp., Smyrna, Ga.

To a portion of the base formulation is added a photoinitiator mixture of Irgacure® 819/Irgacure® 184 in a 1:2 ratio. The photoinitiator mixture is 3.0 weight percent of the total formulation.

Formulations further contain a present additive of (a)-(o) and a convention organohalogen or organophosphorus flame retardant.

Films are prepared with a draw-down bar over a white Scotchcal® vinyl film from 3M. Samples are cured with a moving belt at 58 feet/min. under two medium pressure mercury lamps perpendicular to the belts @ 300 watts/in. each. The prints received one pass under the lamps. Irradiance received is 618 mJ/cm². Final cured thickness is 2.1 mils (53 microns).

The present additives selected from (a)-(o) and a convention organohalogen or organophosphorus flame retardant provide excellent flame retardancy to the photo-cured coatings.

### EXAMPLE 17

### Photo-Cured Clear Coating

A model clear UV-curable coating for wood is prepared based on acrylated aromatic urethane/epoxy chemistry. A base formulation is prepared consisting of:

Ebercryl® 4827, 30.0 g

Ebercryl® 600, 30.0 g

Tripropylene glycol diacrylate (TRPGDA), 40.0 g

Ebercryl® 4827 is an aromatic urethane diacrylate oligomer. Ebercryl® 600 is the diacrylate ester of a bisphenol-A epoxy resin. The Ebecryl® products as well as the acrylate monomers are available from UCB Chemicals Corp., Smyrna, Ga.

To a portion of the base formulation is added a photoinitiator mixture of Irgacure® 819/Irgacure® 184 in a 1:2 ratio. The photoinitiator mixture is 3.0 weight percent of the formulation.

Formulations further contain a present additive selected from (a)-(o) and a conventional organohalogen, organophosphorus, isocyanurate or melamine based flame retardant.

Films are prepared with a draw-down bar over a white Scotchcal® vinyl film from 3M. Samples are cured with a moving belt at 95 feet/min. under two medium pressure mercury lamps perpendicular to the belts @ 300 watts/in. each. The prints received two passes under the lamps. Irradiance received is 750 mJ/cm². Final cured thickness is 5.1 mils (130 microns).

The coatings containing a present additive selected from (a)-(o) and a conventional organohalogen, organophosphorus, isocyanurate or melamine based flame retardant provide excellent flame retardancy.

### EXAMPLE 18

### Photo-Cured White Powder Coating

A typical white, radiation-curable powder coating resin composition consists of the following components in parts by weight: 5-6 parts of an unsaturated polyester amorphous oligomer, 1 part divinyl ether crystalline monomer, 2-3.5 parts rutile titanium dioxide, 0.015 parts flow-aid, 0.02 parts Irgacure® 819 and 0.004 parts Irgacure® 2959. The ingredients are blended together in an extruder and ground into a fine powder. The powder is applied to the substrate to be coated and is subsequently melted with an infrared heat source which allows for continuous film formation. In the melt state the resin is exposed to the radiation source to initiate curing.

Formulations further contain a present additive selected from (a)-(o) and a conventional organohalogen, organophosphorus, isocyanurate or melamine based flame retardant.

Irgacure® 819 is a bisacylphosphine oxide, bis(2,4,6-trimethylbenzoyl)phenylphosphine oxide, and Irgacure® 2959 is 1-(4-(2-hydroxyethoxy)-phenyl)-2-hydroxy-2-methyl-propan-1-one; both available from Ciba Specialty Chemicals Corp.

The white powder coatings containing a present additive selected from (a)-(o) and a conventional organohalogen, organophosphorus, isocyanurate or melamine based flame retardant exhibit excellent flame retardancy.

### EXAMPLE 19

### Photo-Cured White Gel Coat

A typical gel coat formulation consists of an unsaturated polyester oligomer with a styrene diluent added to control viscosity. Styrene is normally present at about 35% by weight. The other components are typically rutile TiO₂, about 10% by weight and Irgacure® 819, about 2% by weight. The mixture is either sprayed, brushed or drawn down on the substrate and cured to a glassy solid state. The cure line speeds are about 60 feet per minute per lamp with Fusion D lamps and about 24 feet per minute per lamp with standard mercury lamps. The film thickness is about 20 mils.

Formulations further contain a present additive selected from (a)-(o) and a conventional organohalogen, organophosphorus, isocyanurate or melamine based flame retardant.

Irgacure® 819 is a bisacylphosphine oxide, bis(2,4,6-trimethylbenzoyl)phenylphosphine oxide, and Irgacure® 2959 is 1-(4-(2-hydroxyethoxy)-phenyl)-2-hydroxy-2-methyl-propan-1-one; both available from Ciba Specialty Chemicals Corp.

The white gel coats containing a present additive selected from (a)-(o) and a conventional organohalogen, organophosphorus, isocyanurate or melamine based flame retardant exhibit excellent flame retardancy.

### EXAMPLE 20

### Intumescent Coatings

Intumescent coatings are prepared according to the following formulation:

weight percent

| | |
|---|---|
| Intumescent base material including a foaming agent, | 20% to 60% |
| a blowing agent, a charring agent, a binding agent, a solvent | |
| and a pigment | |
| Flame spread reduction agent such as ammonium | 2% to 12% |
| orthophosphate, aluminum trihydrate, zinc oxide, zinc borate, | |
| sodium silicate, calcium silicate, antimony oxide, zinc | |
| metaphosphate or potassium metaphosphate | |
| Oxygen reduction agents such as urea, urea formaldehyde, | 1% to 5% |
| dicyandiamide or melamine | |
| Thermal transmission reduction agents such as zirconium | 2% to 6% |
| dioxide, chromium oxide, yttrium oxide or potassium oxide | |
| Refractory fibers such as aluminum oxide, silicon dioxide, ferric | 8% to 18% |
| oxide, sodium oxide zirconium oxide, beryllium oxide, manganese | |
| oxide, zinc oxide, titanium oxide or tantalum oxide | |
| Stabilizer and volatile organic reduction components such as | 6% to 12% |
| erythritol or paraffin | |
| Mechanical enhancer components for physical impact resistance | 1% to 4% |
| and adhesion to a substrate such as calcium carbonate, ceramic | |
| oxides, calcium silicate or sodium silicate | |
| Water resistance agents and efflorescence reduction agents | 4% to 8% |
| such as carboxymethyl cellulose, ethyl hydroxyethyl cellulose, | |
| ammonium polyphosphate, melamine formaldehyde coatings | |
| and other low solubility coatings and acrylics, silicones, diethylene | |
| glycol or nomethyletheracetate | |
| Elasticity agents to increase resistance to cracking and shrinking | 0% to 20% |
| and to improve ease of spraying, such as vermiculite, perlite | |
| elastomerics or acrylics | |

The formulations additionally contain a present additive selected from (a)-(o) and a conventional organohalogen, organophosphorus, isocyanurate or melamine based flame retardant. The coatings are applied to T1-11 siding, cedar shakes, particle board, steel, aluminum, the outer jacket of communication cables, pastic gasoline tanks, doors and ceiling tiles. The coatings are applied at a thickness of 0.012 inches, 0.060 inches, 0.008 inches, 0.010 inches and 0.018 inches. The compositions exhibit excellent flame retardancy.

### EXAMPLE 21

### Coatings for Grease Filled Cable Construction

A typical telecom cable is constructed of twisted pairs of polyolefin-insulated copper wire which are bundled together and protected by a cable sheath. The cable sheath is composed of a metal foil and/or armor in combination with a polymeric jacketing material. The entire system is referred to as “telecom cable”.

To reduce the risk of water penetration into the cable system and to minimize the deleterious effects of moisture on the polyolefin insulation, the system is made water-tight by filling the voids in the cable with a hydrophobic grease. Cable systems of this type are described for example in U.S. Pat. Nos. 3,888,709, 4,044,200, 4,218,577 and 5,502,288.

When telecom cable is protected with a coating comprising a present additive selected from (a)-(o) and a convention organohalogen or organophosphorus flame retardant, excellent flame retardancy is achieved.

### EXAMPLE 22

### Intumescent Mastic Fire Resistant Coatings

Components I and II are prepared as follows:

| | Component I weight percent |
|---|---|
| epoxy resin | 32 |
| halogenated flame retardant | 10 |
| black pigment | 0.01 |
| surfactant | 0.006 |
| ammonium polyphosphate | 9 |
| boric acid | 21 |
| carbon fiber | 0.5 |
| mineral wool fiber | 3 |
| | Component II weight percent |
| tris(2-hydroxyethyl)isocyanurate | 4 |
| amido amine | 16 |
| curing agent | 0.6 |
| surfactant | 0.004 |
| wetting agent | 0.16 |
| Perlite | 4 |
| Aramide fiber | 0.12 |

Component I also contains a present additive selected from (a)-(o).

Components I and II are stored separately, then mixed for application of a mastic coating. The mixed material is applied at a thickness of 0.3 in. to a 5″ by 5″ steel plate 0.25 in. thick. The plate is prepared by priming with a two part epoxy primer and attaching a thermocouple to the center of the back side of the plate. A galvanized mesh is attached to the front side and the front of the plate is coated and allowed to cure for 72 hours.

The coatings exhibit excellent flame retardancy.

The coatings may also comprise a spumific.

### EXAMPLE 23

### Coatings Over Fiberglass

A coating formulation is prepared according to the following:

| | weight percent |
|---|---|
| heat expandable graphite | 20 |
| calcium carbonate | 18 |
| ATH | 1.6 |
| phenol formaldehyde (50% solids) | 22 |
| resorcinol formaldehyde (75% solids) | 0.6 |
| pentaerythritol | 3.5 |
| melamine | 1.7 |
| chloroparaffin | 1.7 |
| AEOROSIL ® silica | 0.06 |
| surfactant | 0.001 |
| catalyst | 0.04 |
| water | 26.5 |
| phenol formaldehyde extender | 5 |

The formulation also comprises a present additive selected from (a)-(o).

Two polyester composite sheets, each with a thickness of 10 mil (0.001 in.) are pressed to the top surface of an OSB panel. Similarly, two polyester composite sheets are pressed to the bottom surface of the panel. An isocyanate based binder is used to secure the sheets to the panel. The top and bottom surfaces are coated with the coating formulations.

Similarly, a 5 mil thick fiberglass sheet is pressed to the top and bottom surfaces of an OSB panel. A phenol formaldehyde resin is used to bond the fiberglass to the panel. The top and bottom surfaces are coated with the coating formulations.

The polyester and fiberglass articles exhibit excellent flame retardancy.

Similarly, sheetrock and aluminum roofing sheet are also coated with the present formulations and also exhibit excellent flame retardancy.

### EXAMPLE 24

### Textile Composite

A mixture of 15% by weight modified polypropylene, 45% by weight heterophasic polypropylene mixture of crystalline propylene/ethylene copolymer and an elastic ethylene/propylene copolymer, 40% by weight coated chalk (ca. 1 micron diameter particle size) and 0.35% of a benzofuranone stabilizer is melted in a twin screw extruder at a maximum temp. of 235° C., homogenized, discharged and granulated. The mixture also comprises a present additive selected from (a)-(o) and a present conventional flame retardant.

On laboratory chill roll equipment, consisting of a plasticizing extruder with a sheet die, suction doctor blade, air knife, cooling rollers, polishing roller, transporting system, cutting device and winding equipment, the granulate is melted in the extruder with a maximum zone temp. of 220° C. and the melt is extruded through the sheet die at a temp. of 220° C. directly onto a supplied nonwoven polypropylene and is fixed and the composite is drawn off, edge trimmed and rolled up. Subsequently, the composite is stretched biaxially in a further step.

The composite has excellent flame retardant properties.

The heterophasic polypropylene portion may be replaced with amorphous polypropylene, and the benzofuranone stabilizer may be replace with a mixture of a hindered phenolic and a phosphite stabilizer, for example a mixture of tetrakis(methylene(3,5-di-t-butylhydroxyhydrocinnamate)methane and tris(2,5-di-t-butylphenhyl)phosphite. A melt adhesive to bond the composite layers may be used, for example an EVA copolymer adhesive. Excellent results are achieved.

### EXAMPLE 25

### Optical Fiber Coatings

A radiation curable optical fiber coating is formulated as below:

| | weight percent |
|---|---|
| urethane acrylate oligomer | 37 |
| bisphenol A epoxy diacrylate | 28 |
| tetraethyleneglycol diacrylate | 21 |
| triethyleneglycol diacrylate | 4 |
| trimethylolpropane triacrylate | 6 |
| benzophenone | 1.5 |
| 2,2-dimethoxy-2-phenylacetophenone | 0.7 |
| benzil | 0.5 |
| diethylamine | 0.6 |
| phenothiazine | 0.01 |
| 2-hydroxy-4-n-octoxybenzophenone | 0.01 |
| silicon | 0.2 |
| N-[(2-vinylbenoamino)-ethyl]-3- | 0.2 |
| aminopropyltrimethoxysilane (40% in MeOH) | |

The coating formulations additionally contain a present additive selected from (a)-(o) and a conventional flame retardant. Other photoinitators are suitable, for example phosphine oxide photoinitiators. The cured coatings exhibit excellent flame retardancy.

1. A flame retardant coating composition which comprises
(A) a coating and
(B) an effective flame retarding amount of a mixture of
(i) at least one compound selected from the group consisting of the
(a) sterically hindered nitroxyl stabilizers,
(b) sterically hindered hydroxylamine stabilizers and
(c) sterically hindered alkoxyamine stabilizers and
(ii) at least one conventional flame retardant,
where the coating is based on a resin selected from alkyd resins; chlorinated alkyd resins; polyurethane resins; thermoplastic acrylic resins: acrylic alkyls; acrylic resins; latex emulsions; acrylic alkyd or polyester resins; acrylic alkyd or polyester resins modified with silicon, isocyanates, ketimines or oxazolidines; phenol-formaldehyde resins; resorcinol-formaldehyde resins; epoxy resins; epoxide resins crosslinked with carboxylic acids, anhydrides, polyamines or mercaptans; and acrylic or polyester resin systems modified with reactive groups in the backbone thereof and crosslinked with epoxide and
where the flame retardants of component (ii) are selected from the group consisting of
chloroalkyl phosphate esters,
tris(2-chloroethyl)phosphate,
polybrominated diphenyl oxide,
decabromodiphenyl oxide,
tris[3-bromo-2,2-bis(bromomethyl)propyl]phosphate,
tris(2,3-dibromopropyl)phosphate,
tris(2,3-dichloropropyl)phosphate,
chlorendic acid,
tetrachlorophthalic acid,
tetrabromophthalic acid,
bis-(N,N′-hydroxyethyl)tetrachlorphenylene diamine,
poly-β-chloroethyl triphosponate mixture,
bis(2,3-dibromopropyl ether) of bisphenol A,
brominated epoxy resin,
ethylene-bis(tetrabromophthalimide),
bis(hexachlorocyclopentadieno)cyclooctane,
octabromodiphenyl ether,
hexachlorocyclopentadiene derivatives,
1,2-bis(tribromophenoxy)ethane,
tetrabromo-bisphenol A,
ethylene bis-(dibromo-norbornanedicarboximide),
bis-(hexachlorocyclopentadieno) cyclooctane,
PTFE,
tris-(2,3-dibromopropyl)-isocyanurate,
ethylene-bis-tetrabromophthalimide,
tetraphenyl resorcinol diphosphite,
triphenyl phosphate,
trioctyl phosphate,
tricresyl phosphate,
tetrakis(hydroxymethyl)phosphonium sulfide,
diethyl-N,N-bis(2-hydroxyethyl)-aminomethyl phosphonate,
hydroxyalkyl esters of phosphorus acids,
resorcinol diphosphate oligomer,
phosphazene flame retardants,
ethylenediamine diphosphate,
polyisocyanurate,
esters of isocyanuric acid,
isocyanurates,
hydroxyalkyl isocyanurates,
melamine cyanurate,
melamine borate,
melamine phosphates,
melamine polyphosphates and
melamine pyrophosphates.

2. A composition according to claim 1 containing no antimony compounds or antimony compounds in an amount less than about 1% by weight based on the weight of the coating component (A).

3. A composition according to claim 1 containing no filler or a filler in an amount less than about 3% by weight based on the weight of the polymer component (A).

4. (canceled)

5. A composition according to claim 1 in which the coating is based on an epoxy resin.

6. (canceled)

7. (canceled)

8. A composition according to claim 1 which is a multilayer coating composition.

9. A composition according to claim 8 in which component (B) is present in one or more than one coating layer of the multilayer composition.

10. A composition according to claim 1 which is ambient cured, radiation cured, oven cured or cured with the aid of a catalyst.

11. A composition according to claim 1 in which the coating is clear or is pigmented.

12. A composition according to claim 1 in which the coating is waterborne or is solvent borne.

13. A composition according to claim 1 in which the coating is a powder coating or a gel coat.

14. A composition according to claim 1 in which the coating is a mastic, an adhesive, a binder, a caulk, a putty, a mortar or sealant.

15. A composition according to claim 1 in which the coating further comprises foaming agents, blowing agents, charring agents, binding agents, thixotropic agents, spumific agents or carbonific materials.

16. A composition according to claim 1 in which the compounds of component (i) are of the formula 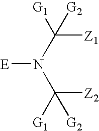
where
G₁ and G₂ are independently alkyl of 1 to 8 carbon atoms or are together pentamethylene,
Z₁ and Z₂ are each methyl, or Z₁ and Z₂ together form a linking moiety which may additionally be substituted by an ester, ether, amide, amino, carboxy or urethane group, and
E is oxyl, hydroxyl, alkoxy, cycloalkoxy, aralkoxy, aryloxy, —O—CO—OZ₃, —O—Si(Z₄)₃, —O—PO(OZ₅)₂ or —O—CH₂—OZ₆ where Z₃, Z₄, Z₅ and Z₆ are selected from the group consisting of hydrogen, an aliphatic, araliphatic and aromatic moiety; or E is —O-T-(OH)_{b},
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms; and
b is 1, 2 or 3 with the proviso that b cannot exceed the number of carbon atoms in T, and when b is 2 or 3, each hydroxyl group is attached to a different carbon atoms of T.

17. A composition according to claim 16 in which the compounds of component (i) are of the formula A-R 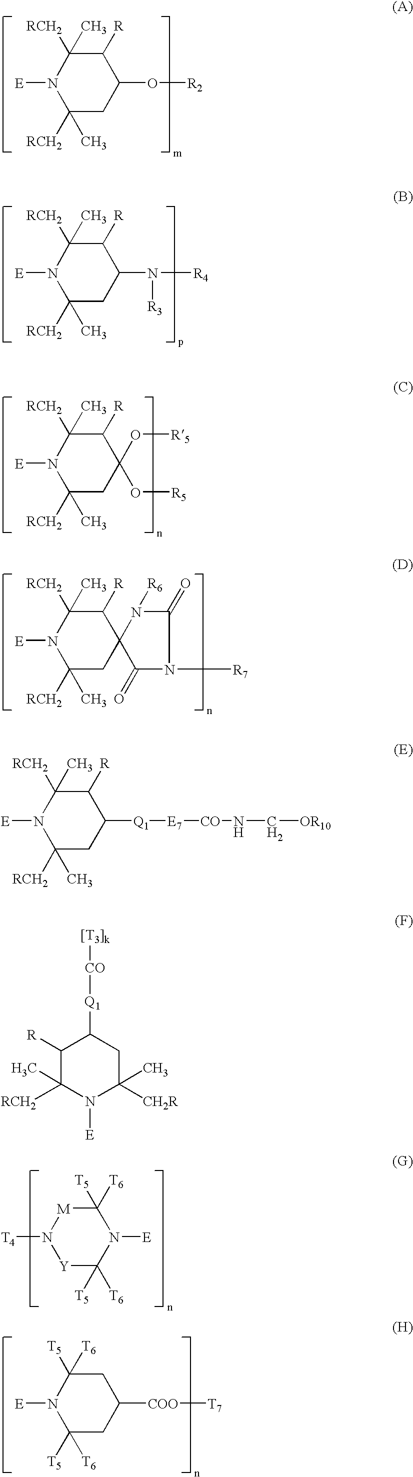 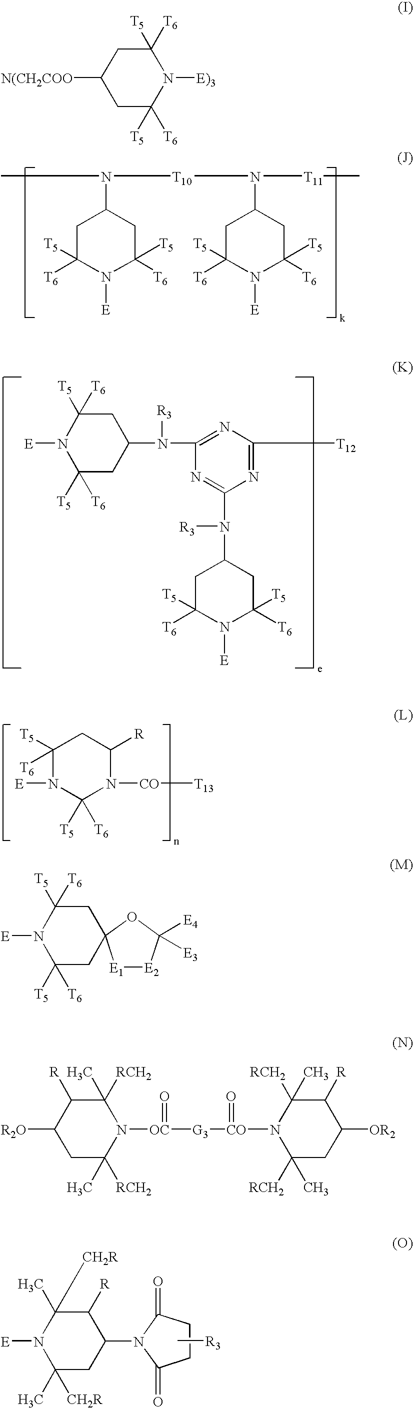 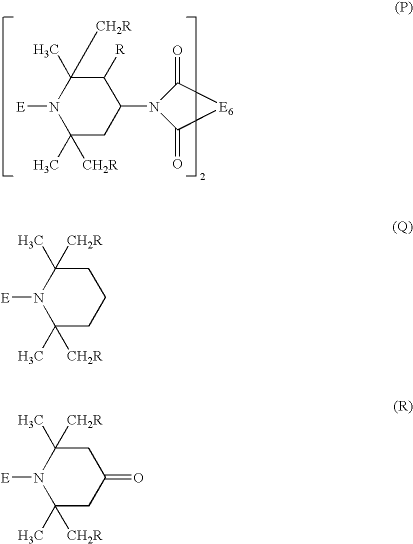
wherein
E is oxyl, hydroxyl, alkoxy of 1 to 18 carbon atoms, cycloalkoxy of 5 to 12 carbon atoms or aralkoxy of 7 to 15 carbon atoms, or E is —O-T-(OH)_{b},
T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms;
b is 1, 2 or 3 with the proviso that b cannot exceed the number of carbon atoms in T, and when b is 2 or 3, each hydroxyl group is attached to a different carbon atoms of T;
R is hydrogen or methyl,
m is 1 to 4,
when m is 1,
R₂ is hydrogen, C₁-C₁₈alkyl or said alkyl optionally interrupted by one or more oxygen atoms, C₂-C₁₂alkenyl, C₆-C₁₀aryl, C₇-C₁₈aralkyl, glycidyl, a monovalent acyl radical of an aliphatic, cycloaliphatic or aromatic carboxylic acid, or a carbamic acid, for example an acyl radical of an aliphatic carboxylic acid having 2-18 C atoms, of a cycloaliphatic carboxylic acid having 5-12 C atoms or of an aromatic carboxylic acid having 7-15 C atoms, or 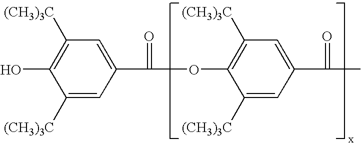
wherein x is 0 or 1, 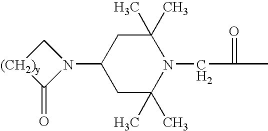
wherein y is 2-4;
when m is 2,
R₂ is C₁-C₁₂alkylene, C₄-C₁₂alkenylene, xylylene, a divalent acyl radical of an aliphatic, cycloaliphatic, araliphatic or aromatic dicarboxylic acid or of a dicarbamic acid, for example an acyl radical of an aliphatic dicarboxylic acid having 2-18 C atoms, of a cycloaliphatic or aromatic dicarboxylic acid having 8-14 C atoms, or of an aliphatic, cycloaliphatic or aromatic dicarbamic acid having 8-14 C atoms; 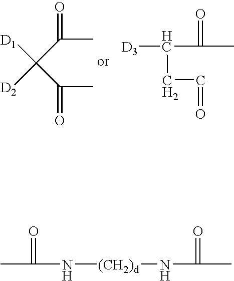
wherein D₁ and D₂ are independently hydrogen, an alkyl radical containing up to 8 carbon atoms, an aryl or aralkyl radical including 3,5-di-t-butyl-4-hydroxybenzyl radical, D₃ is hydrogen, or an alkyl or alkenyl radical containing up to 18 carbon atoms, and d is 0-20;
when m is 3, R₂ is a trivalent acyl radical of an aliphatic, unsaturated aliphatic, cycloaliphatic, or aromatic tricarboxylic acid;
when m is 4, R₂ is a tetravalent acyl radical of a saturated or unsaturated aliphatic or aromatic tetracarboxylic acid including 1,2,3,4-butanetetracarboxylic acid, 1,2,3,4-but-2-enetetracarboxylic, and 1,2,3,5- and 1,2,4,5-pentanetetracarboxylic acid;
p is 1, 2 or 3,
R₃ is hydrogen, C₁-C₁₂alkyl, C₅-C₇cycloalkyl, C₇-C₉aralkyl, C₂-C₁₈alkanoyl, C₃-C₅alkenoyl or benzoyl;
when p is 1,
R₄ is hydrogen, C₁-C₁₈alkyl, C₅-C₇cycloalkyl, C₂-C₈alkenyl, unsubstituted or substituted by a cyano, carbonyl or carbamide group, aryl, aralkyl, or it is glycidyl, a group of the formula —CH₂—CH(OH)-Z or of the formula —CO-Z or —CONH-Z wherein Z is hydrogen, methyl or phenyl; or a group of the formulae 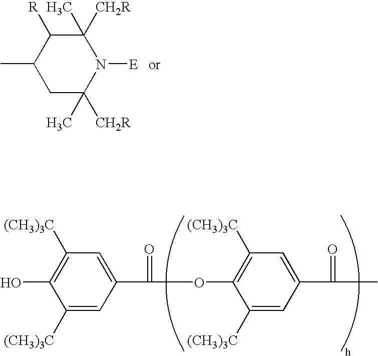
where h is 0 or 1,
R₃ and R₄ together, when p is 1, can be alkylene of 4 to 6 carbon atoms or 2-oxo-polyalkylene the cyclic acyl radical of an aliphatic or aromatic 1,2- or 1 3-dicarboxylic acid,
when p is 2,
R₄ is a direct bond or is C₁-C₁₂alkylene, C₆-C₁₂arylene, xylylene, a —CH₂CH(OH)—CH₂ group or a group —CH₂—CH(OH)—CH₂—O—X—O—CH₂—CH(OH)—CH₂— wherein X is C₂-C₁₀alkylene, C₆-C₁₅arylene or C₆-C₁₂cycloalkylene; or, provided that R₃ is not alkanoyl, alkenoyl or benzoyl, R₄ can also be a divalent acyl radical of an aliphatic, cycloaliphatic or aromatic dicarboxylic acid or dicarbamic acid, or can be the group —CO—; or
R₄is 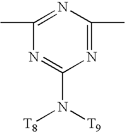
where T₈ and T₉ are independently hydrogen, alkyl of 1 to 18 carbon atoms, or T₈ and T₉ together are alkylene of 4 to 6 carbon atoms or 3-oxapentamethylene, for instance T₈ and T₉ together are 3-oxapentamethylene;
when p is 3,
R₄ is 2,4,6-triazinyl,
n is 1 or 2,
when n is 1,
R₅ and R′₅ are independently C₁-C₁₂ alkyl, C₂-C₁₂ alkenyl, C₇-C₁₂ alkenyl, C₇-C₁₂ aralkyl, or R₅ is also hydrogen, or R₅ and R′₅ together are C₂-C₈alkylene or hydroxyalkylene or C₄-C₂₂acyloxyalkylene;
when n is 2,
R₅ and R′₅ together are (—CH₂)₂C(CH₂—)₂;
R₆ is hydrogen, C₁-C₁₂alkyl, allyl, benzyl, glycidyl or C₂-C₆alkoxyalkyl;
when n is 1,
R₇ is hydrogen, C₁-C₁₂alkyl, C₃-C₅alkenyl, C₇-C₉aralkyl, C₅-C₇cycloalkyl, C₂-C₄hydroxyalkyl, C₂-C₆alkoxyalkyl, C₆-C₁₀ aryl, glycidyl, a group of the formula —(CH₂)ₜ—COO-Q or of the formula —(CH₂)ₜ—O—CO-Q wherein t is 1 or 2, and Q is C₁-C₄alkyl or phenyl; or
when n is 2,
R₇ is C₂-C₁₂alkylene, C₆-C₁₂arylene, a group —CH₂CH(OH)—CH₂—O—X—O—CH₂—CH(OH)—CH₂— wherein X is C₂-C₁₀alkylene, C₆-C₁₅arylene or C₆-C₁₂cycloalkylene, or a group —CH₂CH(OZ′)CH₂—(OCH₂—CH(OZ′)CH₂)₂— wherein Z′ is hydrogen, C₁-C₁₈alkyl, allyl, benzyl, C₂-C₁₂alkanoyl or benzoyl;
Q₁ is —N(R₈)— or —O—; E₇ is C₁-C₃ alkylene, the group —CH₂—CH(R₉)—O— wherein R₉ is hydrogen, methyl or phenyl, the group —(CH₂)₃—NH— or a direct bond;
R₁₀ is hydrogen or C₁-C₁₈ alkyl, R₈ is hydrogen, C₁-C₁₈alkyl, C₅-C₇cycloalkyl, C₇-C₁₂aralkyl, cyanoethyl, C₆-C₁₀aryl, the group —CH₂—CH(R₉)—OH wherein R₉ has the meaning defined above; a group of the formula 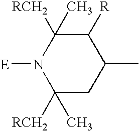
or a group of the formula 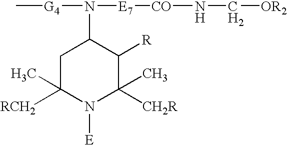
wherein G₄ is C₂-C₆alkylene or C₆-C₁₂arylene; or R₈ is a group -E₇-CO—NH—CH₂—OR₁₀;
Formula F denotes a recurring structural unit of a polymer where T₃ is ethylene or 1,2-propylene, is the repeating structural unit derived from an alpha-olefin copolymer with an alkyl acrylate or methacrylate; for example a copolymer of ethylene and ethyl acrylate, and where k is 2 to 100;
T₄ has the same meaning as R₄ when p is 1 or 2,
T₅ is methyl,
T₆ is methyl or ethyl, or T₅ and T₆ together are tetramethylene or pentamethylene, for instance T₅ and T₆ are each methyl,
M and Y are independently methylene or carbonyl, and T₄ is ethylene where n is 2;
T₇ is the same as R₇, and T₇ is for example octamethylene where n is 2,
T₁₀ and T₁₁ are independently alkylene of 2 to 12 carbon atoms, or T₁₁ is 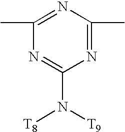
T₁₂ is piperazinyl, 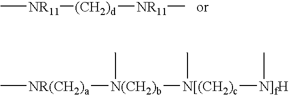
where R₁₁ is the same as R₃ or is also 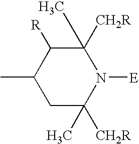
a, b and c are independently 2 or 3, and f is 0 or 1, for instance a and c are each 3, b is 2 and f is 1; and
e is 2, 3 or 4, for example 4;
T₁₃ is the same as R₂ with the proviso that T₁₃ cannot be hydrogen when n is 1;
E₁ and E₂, being different, each are —CO— or —N(E₅)— where E₅ is hydrogen, C₁-C₁₂ alkyl or C₄-C₂₂ alkoxycarbonylalkyl, for instance E₁ is —CO— and E₂ is —N(E₅)—,
E₃ is hydrogen, alkyl of 1 to 30 carbon atoms, phenyl, naphthyl, said phenyl or said naphthyl substituted by chlorine or by alkyl of 1 to 4 carbon atoms, or phenylalkyl of 7 to 12 carbon atoms, or said phenylalkyl substituted by alkyl of 1 to 4 carbon atoms,
E₄ is hydrogen, alkyl of 1 to 30 carbon atoms, phenyl, naphthyl or phenylalkyl of 7 to 12 carbon atoms, or
E₃ and E₄ together are polymethylene of 4 to 17 carbon atoms, or said polymethylene substituted by up to four alkyl groups of 1 to 4 carbon atoms, for example methyl,
E₆ is an aliphatic or aromatic tetravalent radical,
R₂ of formula (N) is a previously defined when m is 1;
G₁ a direct bond, C₁-C₁₂ alkylene, phenylene or —NH-G′-NH wherein G′ is C₁-C₁₂ alkylene; or
wherein the hindered amine compound is a compound of the formula I, II, III, IV, V, VI, VII, VIII, IX, X or XI 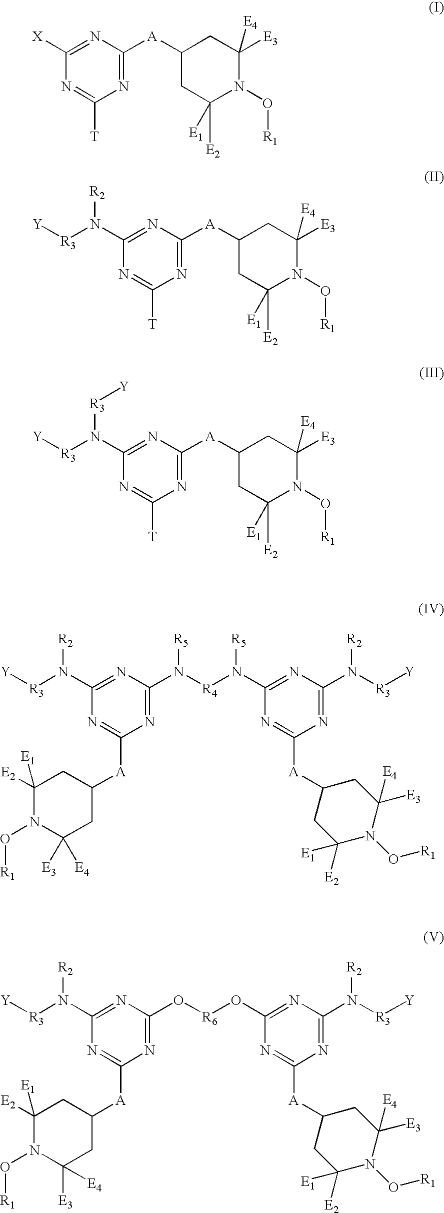 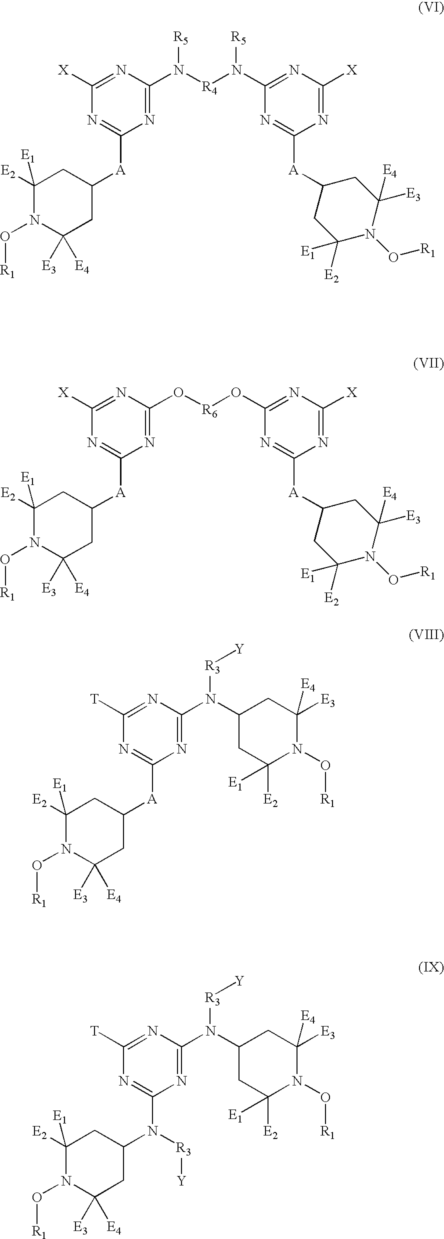 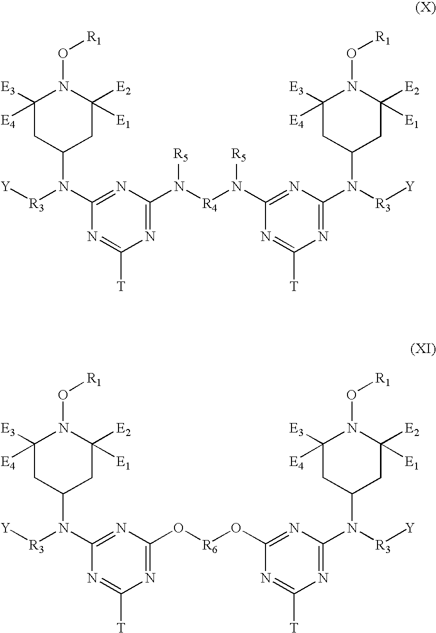
wherein
E₁, E₂, E₃ and E₄ are independently alkyl of 1 to 4 carbon atoms, or E₁ and E₂ are independently alkyl of 1 to 4 carbon atoms and E₃ and E₄ taken together are pentamethylene, or E₁ and E₂; and E₃ and E₄ each taken together are pentamethylene,
R₁ is alkyl of 1 to 18 carbon atoms, cycloalkyl of 5 to 12 carbon atoms, a bicyclic or tricyclic hydrocarbon radical of 7 to 12 carbon atoms, phenylalkyl of 7 to 15 carbon atoms, aryl of 6 to 10 carbon atoms or said aryl substituted by one to three alkyl of 1 to 8 carbon atoms,
R₂ is hydrogen or a linear or branched chain alkyl of 1 to 12 carbon atoms,
R₃ is alkylene of 1 to 8 carbon atoms, or R₃ is —CO—, —CO—R₄—, —CONR₂—, or —CO—NR₂—R₄—,
R₄ is alkylene of 1 to 8 carbon atoms,
R₅ is hydrogen, a linear or branched chain alkyl of 1 to 12 carbon atoms, or 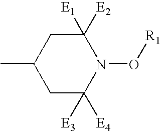
or when R₄ is ethylene, two R₅ methyl substituents can be linked by a direct bond so that the triazine bridging group —N(R₅)—R₄—N(R₅)— is a piperazin-1,4-diyl moiety,
R₆ is alkylene of 2 to 8 carbon atoms or R₆ is 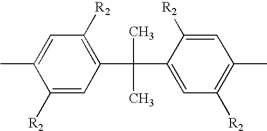
with the proviso that Y is not —OH when R₆ is the structure depicted above,
A is —O— or —NR₇— where R₇ is hydrogen, a straight or branched chain alkyl of 1 to 12 carbon atoms, or R₇ is 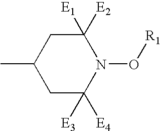
T is phenoxy, phenoxy substituted by one or two alkyl groups of 1 to 4 carbon atoms, alkoxy of 1 to 8 carbon atoms or —N(R₂)₂ with the stipulation that R₂ is not hydrogen, or T is 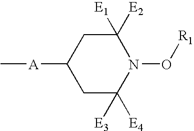
X is —NH₂, —NCO, —OH, —O-glycidyl, or —NHNH₂, and
Y is —OH, —NH₂, —NHR₂ where R₂ is not hydrogen; or Y is —NCO, —COOH, oxiranyl, —O-glycidyl, or —Si(OR₂)₃; or the combination R₃—Y— is —CH₂CH(OH)R₂ where R₂ is alkyl or said alkyl interrupted by one to four oxygen atoms, or R₃—Y— is —CH₂OR₂; or
wherein the hindered amine compound is a mixture of N,N′,N′″-tris{2,4-bis[(1-hydrocarbyloxy-2,2,6,6-tetramethylpiperidin-4-yl)alkylamino]-s-triazin-6-yl}-3,3′-ethylenediiminodipropylamine; N,N′,N″-tris{2,4-bis[(1-hydrocarbyloxy-2,2,6,6-tetramethylpiperidin-4-yl)alkylamino]-s-triazin-6-yl}-3,3′-ethylenediiminodipropylamine, and bridged derivatives as described by formulas I, II, IIA and III
R₁NH—CH₂CH₂CH₂NR₂CH₂CH₂NR₃CH₂CH₂CH₂NHR₄ (I)
T-E₁-T₁ (II)
T-E₁ (IIA)
G-E₁-G₁-E₁-G₂ (III)
where in the tetraamine of formula I
R₁ and R₂ are the s-triazine moiety E; and one of R₃ and R₄ is the s-triazine moiety E with the other of R₃ or R₄ being hydrogen,
E is 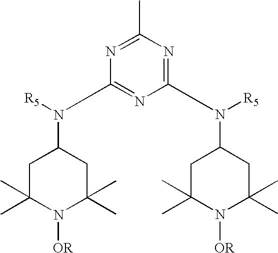
R is methyl, propyl, cyclohexyl or octyl, for instance cyclohexyl,
R₅ is alkyl of 1 to 12 carbon atoms, for example n-butyl,
where in the compound of formula II or IIA when R is propyl, cyclohexyl or octyl,
T and T₁ are each a tetraamine substituted by R₁-R₄ as is defined for formula I, where
(1) one of the s-triazine moieties E in each tetraamine is replaced by the group E₁ which forms a bridge between two tetraamines T and T₁,
E₁ is 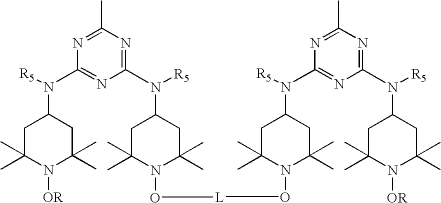
or
(2) the group E₁ can have both termini in the same tetraamine T as in formula IIA where two of the E moieties of the tetraamine are replaced by one E₁ group, or
(3) all three s-triazine substituents of tetraamine T can be E₁ such that one E₁ links T and T₁ and a second E₁ has both termini in tetraamine T,
L is propanediyl, cyclohexanediyl or octanediyl;
where in the compound of formula III
G, G₁ and G₂ are each tetraamines substituted by R₁-R₄ as defined for formula I, except that G and G₂ each have one of the s-triazine moieties E replaced by E₁, and G₁ has two of the triazine moieties E replaced by E₁, so that there is a bridge between G and G₁ and a second bridge between G₁ and G₂;
which mixture is prepared by reacting two to four equivalents of 2,4-bis[(1-hydrocarbyloxy-2,2,6,6-piperidin-4-yl)butylamino]-6-chloro-s-triazine with one equivalent of N,N′-bis(3-aminopropyl)-ethylenediamine;
or the hindered amine is a compound of the formula IIIb 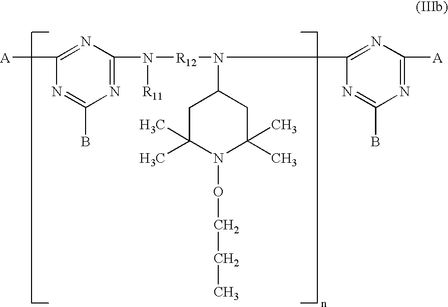
in which the index n ranges from 1 to 15;
R₁₂ is C₂-C₁₂alkylene, C₄-C₁₂alkenylene, C₅-C₇cycloalkylene, C₅-C₇cycloalkylene-di(C₁-C₄alkylene), C₁-C₄alkylenedi(C₅-C₇cycloalkylene), phenylenedi(C₁-C₄alkylene) or C₄-C₁₂alkylene interrupted by 1,4-piperazinediyl, —O— or>N—X₁ with X₁ being C₁-C₁₂acyl or (C₁-C₁₂alkoxy)carbonyl or having one of the definitions of R₁₄ given below except hydrogen; or R₁₂ is a group of the formula (Ib′) or (Ic′); 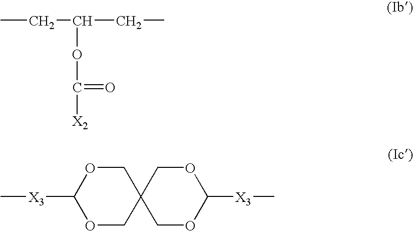
with m being 2 or 3,
X₂ being C₁-C₁₈alkyl, C₅-C₁₂cycloalkyl which is unsubstituted or substituted by 1, 2 or 3 C₁-C₄alkyl; phenyl which is unsubstituted or substituted by 1, 2 or 3 C₁-C₄alkyl or C₁-C₄alkoxy; C₇-C₉phenylalkyl which is unsubstituted or substituted on the phenyl by 1, 2 or 3 C₁-C₄alkyl; and
the radicals X₃ being independently of one another C₂-C₁₂alkylene;
R₁₃, R₁₄ and R₁₅, which are identical or different, are hydrogen, C₁-C₁₈alkyl, C₅-C₁₂cycloalkyl which is unsubstituted or substituted by 1, 2 or 3 C₁-C₄alkyl; C₃-C₁₈alkenyl, phenyl which is unsubstituted or substituted by 1, 2 or 3 C₁-C₄alkyl or C₁-C₄alkoxy; C₇-C₉phenylalkyl which is unsubstituted or substituted on the phenyl by 1, 2 or 3 C₁-C₄alkyl; tetrahydrofurfuryl or C₂-C₄alkyl which is substituted in the 2, 3 or 4 position by —OH, C₁-C₈alkoxy, di(C₁-C₄alkyl)amino or a group of the formula (Ie′); 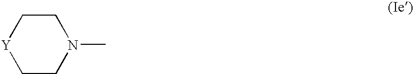
with Y being —O—, —CH₂—, —CH₂CH₂— or>N—CH₃,
or —N(R₁₄)(R₁₅) is additionally a group of the formula (Ie′);
the radicals A are independently of one another —OR₁₃, —N(R₁₄)(R₁₅) or a group of the formula (IIId); 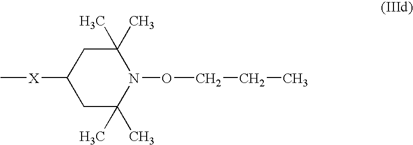
X is —O— or>N—R₁₆;
R₁₆ is hydrogen, C₁-C₁₈alkyl, C₃-C₁₈alkenyl, C₅-C₁₂cycloalkyl which is unsubstituted or substituted by 1, 2 or 3 C₁-C₄alkyl; C₇-C₉phenylalkyl which is unsubstituted or substituted on the phenyl by 1, 2 or 3 C₁-C₄alkyl; tetrahydrofurfuryl, a group of the formula (IIIf), 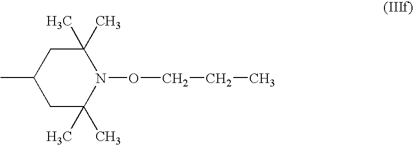
or C₂-C₄alkyl which is substituted in the 2, 3 or 4 position by —OH, C₁-C₈alkoxy, di(C₁-C₄alkyl)amino or a group of the formula (Ie′);
R₁₁ has one of the definitions given for R₁₆; and
the radicals B have independently of one another one of the definitions given for A.

18. A composition according to claim 16 in which the compounds of component (i) are selected from the group consisting of
(a) the reaction product of 2,4-bis[(1-cyclohexyloxy-2,2,6,6-piperidin-4-yl)butylamino]-6-chloro-s-triazine with N,N′-bis(3-aminopropyl)ethylenediamine);
(b) 1-cyclohexyloxy-2,2,6,6-tetramethyl-4-octadecylaminopiperidine;
(c) bis(1-octyloxy-2,2,6,6-tetramethylpiperidin-4-yl)sebacate;
(d) 2,4-bis[(1-cyclohexyloxy-2,2,6,6-tetramethylpiperidin-4-yl)butylamino]-6-(2-hydroxyethyl-amino-s-triazine;
(e) bis(1-cyclohexyloxy-2,2,6,6-tetramethylpiperidin-4-yl)adipate;
(h) 2,4-bis[(1-cyclohexyloxy-2,2,6,6-piperidin-4-yl)butylamino]-6-chloro-s-triazine;
(i) 1-(2-hydroxy-2-methylpropoxy)-4-hydroxy-2,2,6,6-tetramethylpiperidine;
(j) 1-(2-hydroxy-2-methylpropoxy)-4-oxo-2,2,6,6-tetramethylpiperidine;
(k) 1-(2-hydroxy-2-methylpropoxy)-4-octadecanoyloxy-2,2,6,6-tetramethylpiperidine;
(l) bis(1-(2-hydroxy-2-methylpropoxy)-2,2,6,6-tetramethylpiperidin-4-yl)sebacate;
(m) bis(1-(2-hydroxy-2-methylpropoxy)-2,2,6,6-tetramethylpiperidin-4-yl)adipate;
(n) 2,4-bis{N-[1-(2-hydroxy-2-methylpropoxy)-2,2,6,6-tetramethylpiperidin-4-yl]-N-butylamino}-6-(2-hydroxyethylamino)-s-triazine; and
(o) the compound of formula 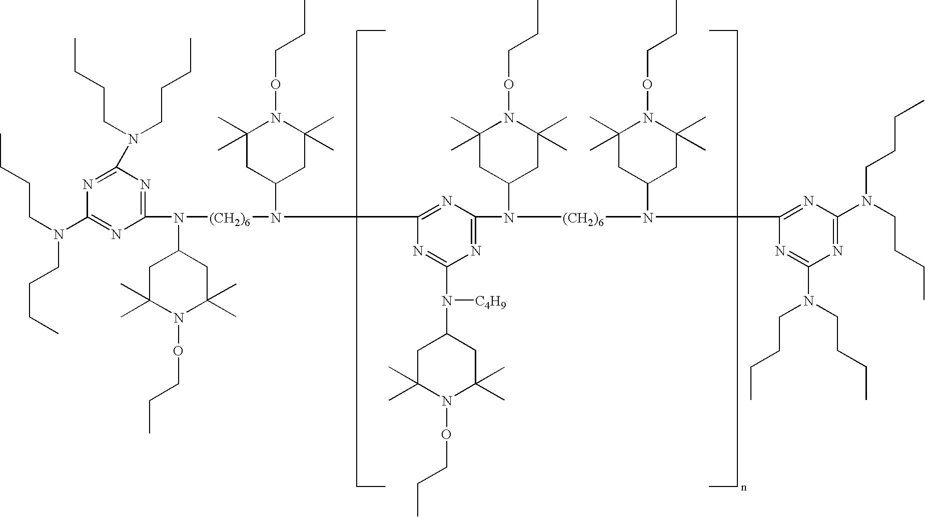
in which n is from 1 to 15.

19. A composition according to claim 1 in which component (i) is present from about 0.1 to about 10% by weight based on the coating component (A).

20. (canceled)

21. A composition according to claim 1 in which the flame retardants of component (ii) are selected from the group consisting of
chloroalkyl phosphate esters,
polybrominated diphenyl oxide,
decabromodiphenyl oxide,
tris[3-bromo-2,2-bis(bromomethyl)propyl] phosphate,
bis(2,3-dibromopropyl ether) of bisphenol A,
brominated epoxy resin,
ethylene-bis(tetrabromophthalimide),
bis(hexachlorocyclopentadieno)cyclooctane,
1,2-bis(tribromophenoxy)ethane,
tetrabromo-bisphenol A,
ethylene bis-(dibromo-norbornanedicarboximide),
bis-(hexachlorocyclopentadieno)cyclooctane,
tris-(2,3-dibromopropyl)-isocyanurate,
ethylene-bis-tetrabromophthalimide
tris-(2-hydroxyethyl)isocyanurate,
tris(hydroxymethyl)isocyanurate,
tris(3-hydroxy-n-proyl)isocyanurate,
triglycidyl isocyanurate,
melamine cyanurate,
melamine borate,
melamine phosphates,
melamine polyphosphates and
melamine pyrophosphates.

22. A composition according to claim 1 in which the flame retardants of component (ii) are present from about 0.5 to about 45% by weight based on the weight of the coating (A).

23. A composition according to claim 1 comprising a further component selected from the group consisting of pigments, dyes, plasticizers, phenolic antioxidants, thixotropic agents, levelling assistants, basic costabilizers, nitrone stabilizers, amine oxide stabilizers, benzofuranone stabilizers, UV absorbers, sterically hindered amines, metal passivators, metal oxides, organophosphorus compounds, hydroxylamines, and mixtures thereof.

24. A flame retardant coated article comprising
a substrate coated with a flame retardant coating composition comprising
(A) a coating and
(B) an effective flame retarding amount of a mixture of
(i) at least one compound selected from the group consisting of the
(a) sterically hindered nitroxyl stabilizers,
(b) sterically hindered hydroxylamine stabilizers and
(c) sterically hindered alkoxyamine stabilizers and
(ii) at least one conventional flame retardant,
where the coating is based on a resin selected from alkyd resins; chlorinated alkyd resins; polyurethane resins; thermoplastic acrylic resins; acrylic alkyls; acrylic resins; latex emulsions; acrylic alkyd or polyester resins; acrylic alkyd or polyester resins modified with silicon, isocyanates, ketimines or oxazolidines; phenol-formaldehyde resins; resorcinol-formaldehyde resins; epoxy resins; epoxide resins crosslinked with carboxylic acids, anhydrides, polyamines or mercaptans; and acrylic or polyester resin systems modified with reactive groups in the backbone thereof and crosslinked with epoxide and
where the flame retardants of component (ii) are selected from the group consisting of
chloroalkyl phosphate esters,
tris(2-chloroethyl)phosphate,
polybrominated diphenyl oxide,
decabromodiphenyl oxide,
tris[3-bromo-2,2-bis(bromomethyl)propyl] phosphate,
tris(2,3-dibromopropyl)phosphate,
tris(2.3-dichloropropyl)phosphate,
chlorendic acid,
tetrachlorophthalic acid,
tetrabromophthalic acid,
bis-(N,N′-hydroxyethyl)tetrachlorphenylene diamine,
poly-β-chloroethyl triphosponate mixture,
bis(2,3-dibromopropyl ether) of bisphenol A,
brominated epoxy resin,
ethylene-bis(tetrabromophthalimide),
bis(hexachlorocyclopentadieno)cyclooctane,
octabromodiphenyl ether,
hexachlorocyclopentadiene derivatives,
1,2-bis(tribromophenoxy)ethane,
tetrabromo-bisphenol A,
ethylene bis-(dibromo-norbornanedicarboximide),
bis-(hexachlorocyclopentadieno)cyclooctane,
PTFE,
tris-(2,3-dibromopropyl)-isocyanurate,
ethylene-bis-tetrabromophthalimide,
tetraphenyl resorcinol diphosphite,
triphenyl phosphate,
trioctyl phosphate,
tricresyl phosphate,
tetrakis(hydroxymethyl)phosphonium sulfide,
diethyl-N,N-bis(2-hydroxyethyl)-aminomethyl phosphonate,
hydroxyalkyl esters of phosphorus acids,
resorcinol diphosphate oligomer,
phosphazene flame retardants,
ethylenediamine diphosphate,
polyisocyanurate,
esters of isocyanuric acid,
isocyanurates,
hydroxyalkyl isocyanurates,
melamine cyanurate,
melamine borate,
melamine phosphates,
melamine polyphosphates and
melamine pyrophosphates.

25. A coated article according to claim 24 in which the substrate is selected from the group consisting of iron, steel, stainless steel, aluminum and other non-ferrous metals, wood, plywood, paper, cardboard, chip board, particle board, plastics, thermoplastics, epoxies, neoprene, rubber, composites, fiberglass reinforced composites, polyesters, polymeric foam, masonry, fabric or textiles, wire and cable constructions and circuit boards.

26. A coated article according to claim 25 in which the plastics are polyvinyl chloride, polycarbonate, polyolefin, thermoplastic polyolefin, ABS or polyester.

27. A coated article according to claim 25 in which the fabric or textile is woven, knitted or nonwoven and is based on polyethylene, polypropylene, polyethylene terephthalate, polyamide, cellulose or cotton.

28. A coated article according to claim 24 which is an automotive thermoplastic olefin structure.

29. A coated article according to claim 24 in which the coating is an extruded plastic.

30. A coated article according to claim 24 which is a coextruded plastic article.

31. A composition according to claim 1 in which the coating is from about 5 microns to about 10 mil thick.
